(19) United States
(12) Patent Application Publication
(10) Pub. No.: US 2010/0056271 A1
(43) Pub. Date: Mar. 4, 2010

(54) Method and system for providing dynamic casino game signage with selectable messaging timed to play of a table game

(76) Inventors: Perry B. Stasi, Henderson, NV (US); Ryan P. McClellan, Las Vegas, NV (US)

Correspondence Address: GREENBERG TRAURIG (LV), 3773 HOWARD HUGHES PARKWAY, Suite 400 North, LAS VEGAS, NV, 89169, US

(21) Appl. No.: 11/590,283

(22) Filed: Oct. 31, 2006

Related U.S. Application Data
(63) Continuation-in-part of application No. 11/245,930, filed on Oct. 7, 2005.
Application No. 11/245,930 is a continuation-in-part of application No. 11/359,225, filed on Feb. 22, 2006, now abandoned.
(60) Provisional application No. 60/683,753, filed on May 23, 2005.

(51) Int. Cl. A63F 13/00

(52) U.S. Cl. 463/30

(57) ABSTRACT

A casino business methodology and apparatus for providing casino game signage for a casino game which incorporates display information that is dynamically interchangeable between game specific and game non-specific information responsive to automatic detection of game play status at the game table. At least one electronic display is provided at respective casino game tables, and selected display information is wirelessly transmitted, and/or manually delivered, thereto. The display information which is displayed is dynamically selected based upon a sensor automatically detecting the status of play of the game, being game specific during play and selectively game specific and game non-specific during game play inactivity.

### CROSS-REFERENCE TO RELATED APPLICATIONS

The present application is a continuation-in-part of provisional patent application Ser. No. 60/683,753 filed on May 23, 2005, which provisional application is now expired, a continuation-in-part of regular patent application Ser. No. 11/245,930, filed on Oct. 7, 2005, which regular application is presently pending, and a continuation-in-part of regular patent application Ser. No. 11/359,225, filed on Feb. 22, 2006, which regular application is also presently pending.

### TECHNICAL FIELD

The present invention relates to signage used in casinos to inform players of game information at game tables. More particularly, the present invention relates to a method and system for providing casino game signage, wherein the information (or messaging) displayed is dynamically switchable, responsive to the status of play of a game, selectively between game specific information and game non-specific information.

### BACKGROUND OF THE INVENTION

Casino games have various rules of play, for example limits on betting amounts, as well as odds, and/or various features of play of the game. Generally speaking, at each game, casino game signage is provided for conveying to the players game specific information. Ordinarily, this signage is in the form of a static placard, but may be also in the form of an electronic display. However, the casino game signage of any specific game need not be statically displayed at all times, as there are times when the game is inactive, as for example when paused during card shuffling, when the game is idle due to no players, or is closed, during which inactive times other forms of display could be provided or also provided.

The business of most casinos involves more than gaming, including, for example, restaurants, shows, exhibits, hostelry, and a plethora of other facilities. It would be, therefore, beneficial to the casino if in various places around the gaming floor advertisements and other information could be provided to the casino patrons.

Accordingly, what remains needed in casino operations is to somehow provide a method and/or system in which casino game signage can incorporate information that is not game specific.

### SUMMARY OF THE INVENTION

The present invention is a casino methodology and system in which casino game signage for a casino game incorporates selectable messaging in the form of display information that is displayed in a dynamically interchangeable manner between game specific information and game non-specific information responsive to the status of play of the game at the game table of the game.

According to the present invention, an electronic display is provided at one or more casino game tables, at least one display for each game table, respectively, preferably at game tables throughout a casino. The game tables may be for a variety of games, as for a non-limiting example blackjack tables, roulette tables, baccarat tables, craps tables, etc. The display may utilize a screen provided by any electronic display technology, for example a cathode ray tube (CRT), but is more preferably a plasma or liquid crystal diode (LCD) display screen. The display preferably includes an electronic interface which drives the display in response to receiving an output from a microprocessor.

By way of example of hardware for carrying out the present invention, a microprocessor (by “microprocessor” is meant a computational device conventionally inclusive of a central processing unit, memory, I/O interfaces, etc.) processes display information for being selectively displayed at the screen of the display, the display information being composed of game specific and game non-specific information, wherein the microprocessor may be located at the display, at a remote location, or both. In one hardware illustration, a microprocessor is located at a remote location, this microprocessor being designated as a “central microprocessor”. The central microprocessor electronically communicates with an electronic interface or to a microprocessor at each display, respectively, which communication could be by direct wire, but is most preferably by wireless transmission. In a second hardware illustration, there is no central microprocessor and a microprocessor is located at each display, respectively, wherein the display includes a data port for receiving microprocessor programming and display information (ie., game specific and game non-specific information) for being displayed at the screen of the display responsive to the microprocessor programming. It is preferred for the display to include a plurality of keys for controlling or altering the microprocessor programming and/or the display information, and/or entering the status of play of the game. It is further preferred for a sensor to automatically detect the status of play of the game, which status information is available to the microprocessor programming.

Displaying, selectively, at least one of the game specific information and the game non-specific information at the display is related to the status of play of the game at the game table. For example, when the status of play of the game at the game table is “inactive”, there are, for non-limiting example, three possible types of game play inactivity: the game play may be “closed”, wherein the game table is closed for playing of the game; the game play may be “idle”, wherein the game table is open for playing of the game but no one is presently playing; or, the game play may be “paused”, wherein the game is in play but paused as for example during a dealer's cards shuffle procedure, between the end of play of one game and the start of the next. When the status of play of the game is inactive, the microprocessor programming causes to be displayed at the display the game non-specific information, but also causes to be displayed the game specific information if the game play inactivity is due to the game play being idle or paused, wherein the display information displayed may be correlated to the type of game play inactivity (for example, if the game play inactivity is due to the game play being closed, preselected non-game specific information may then be displayed which is appropriate to a long duration of game play inactivity). When the status of play of the game is active (ie., the game is actively in play), the microprocessor programming causes to be displayed at the display, preferably only, the game specific information. The display information displayed may be in static format and/or may be in moving picture format (ie., video, streaming video, etc.), and may or may not include sound.

According to the method of the present invention, the displaying of the display information (ie., game specific information and game non-specific information) may be dynamically changed at a remote location, at the display, or both.

According to a first example of the method according to the present invention, microprocessor programming and display information in the form of game specific information (ie., game title, betting limits, and casino identification, etc.) and game non-specific information (ie., advertisements, announcements, etc.) are provided and, from one or more locations in the casino, wirelessly sent to the displays at selected portions of the casino or throughout the casino. In this regard, the term “game specific information” means any information related to the game, including by way of illustration, but not limitation, the game title, the game betting limits, rules of play of the game, and identification of the casino or other facility whereat the game is played; and the term “game non-specific information” means any information unrelated to the game, including by way of illustration, but not limitation, advertisements, casino facilities information, announcements, and entertainment. It is to be understood that identification of the casino or other facility whereat the game is played can be considered game non-specific information, as well as being game specific information. Some displays may receive different game non-specific information depending, for example, upon location of game tables in the casino, the game betting limits, or the type of game that the game is. Additionally, or alternatively, casino personnel (ie., a dealer or pit manager) may change the display information and/or the microprocessor programming of the display at his/her game table using the various keys thereat, as for example to switch between game specific and game non-specific information based upon, for example, the status of play of the game at the game table. With regard to switching display based upon status of play of the game, it is most preferred for a sensor (ie., an electro-optical sensor detecting absence/presence of game play article (ie., a card, puck, etc.) with respect to a location of the game table) to automatically detect the status of play of the game, which status information is available to the microprocessor programming.

Further for example, by way additionally or alternatively to the method described immediately above, the microprocessor programming and the display information in the form of game specific information and game non-specific information may be physically delivered to each display based upon data stored in a removable data storage device, as for example a laptop (notebook) computer with a data transfer cable (ie., a USB cable), a CD/DVD disk, a USB flash memory drive, etc., most preferably a flash memory card, being inserted into a data port of the display, as for example a CD/DVD drive port and/or an SD card port or other flash card port or a USB port. The microprocessor programming and/or the display information may remain on the data storage device and/or may be uploaded to a data storage device or microprocessor memory within the display. The display information and/or microprocessor programming is periodically changed by inserting into, or connecting to, the data port a data storage device having new or revised microprocessor programming and/or display information stored therein, and may also be changed remotely (ie., by wireless communication) and/or by an operator (ie., dealer or casino personnel) manually via keys at the display. As mentioned above, with regard to switching display based upon status of play of the game, it is most preferred for a sensor (ie., an electro-optical sensor detecting absence/presence of game play article (ie., a card, puck, etc.) with respect to a location of the game table) to automatically detect the status of play of the game, which status information is available to the microprocessor programming. As further mentioned above, some displays may receive different game non-specific information depending, for example, upon location of game tables in the casino, the game bet limits, or the type of game that the game is.

It is an aspect of the present invention that the automatic detection of the status of play of the game may be combined with manual input (ie., casino personnel manual key press input) of status of play of the game.

According to an additional aspect of the method according to the present invention, it is preferred to dynamically change the game specific information in response to preselected game play inactivity. For example, if the game play is idle for a predetermined period of time, then the betting limits would be manually or automatically lowered as an inducement to attract players to play the game at the game table and thereby encourage termination of the idleness of play.

According to a method of implementation of the present invention, advertisers are contracted with respect to paid advertisements for one or more display segments of the display of game non-specific information. Upon obtaining a contract with a casino for installation of displays at table games, the displays and associated electronics are installed in the casino at various table games thereof, wherein the casino may receive the displays at no cost. Display segments of game non-specific information are determined and allocated among one or more of the advertisers and, preferably, also the casino. Thereupon, the invention as previously described is implemented with respect to selective display of game specific and game non-specific information.

Accordingly, it is an object of the present invention to provide a method and system in which casino game signage for a casino game incorporates display information that is dynamically interchangeable between game specific and game non-specific information responsive to the status of play of the game at the game table.

This and additional objects, features and advantages of the present invention will become clearer from the following specification of a preferred embodiment.

### BRIEF DESCRIPTION OF THE DRAWINGS

FIG. 1 is a schematic diagram of an implementation of the present invention.

FIG. 2 is a flow chart of a first example for carrying out the method according to the present invention.

FIG. 2A is an alternative flow chart of the first example of FIG. 2, wherein status of play of the game is automatically detected.

FIG. 3 is a flow chart of a second example for carrying out the method according to the present invention.

FIG. 3A is an alternative flow chart of the second example of FIG. 3, wherein status of play of the game is automatically detected.

FIG. 3B is an alternative flow chart of the second example of FIG. 3A, wherein game paused timing is predetermined.

FIG. 4A is a schematic view of a display according to the present invention, wherein the display is displaying a first example of game specific information.

FIG. 4B is a schematic view of the display of FIG. 4A, wherein now the display is displaying a second example of game specific information.

FIG. 4C is a schematic view of the display of FIG. 4A, wherein now the display is displaying game non-specific information.

FIG. 4D is a schematic view of the display of FIG. 4A, wherein now the display is displaying both game non-specific information and game specific information.

FIG. 5A is a schematic view of a first type of keypad for controlling the information displayed by the displays of FIGS. 4A through 4D according to a first aspect of the method according to the present invention.

FIG. 5B is a schematic view of second type of keypad for controlling the information displayed by the displays of FIGS. 4A through 4D according to a second aspect of the method according to the present invention.

FIG. 6A is a schematic view of a display similar to that of FIGS. 4A through 4D, wherein now keys for controlling the information displayed are provided on the display itself rather than on a keypad.

FIG. 6B is a side view, seen along lines 6B-6B of FIG. 6A.

FIG. 6C is a rear view, seen along lines 6C-6C of FIG. 6B.

FIG. 7A is a front perspective view of a preferred display.

FIG. 7B is a rear perspective view of the preferred display of FIG. 7A.

FIG. 8A is a perspective view of a discard rack equipped with a card detector according to the present invention.

FIG. 8B is a perspective view as in FIG. 8A, wherein now a card is present in the discard rack, in overlying relation to the card detector.

FIG. 8C is a partly sectional view of the discard rack of FIG. 8A, wherein a card is present.

FIG. 8D is a partly sectional view of the discard rack of FIG. 8A, wherein a card is absent.

FIG. 9A is a plan view of a blackjack table equipped with the display of FIG. 7A and the discard rack of FIG. 8A.

FIG. 9B is a plan view of a craps table equipped with the display of FIG. 7A and a status of game play detector, both located at each wing of the layout.

FIG. 10 is a flow chart for a method of implementation of the present invention.

FIGS. 11A through 11C are schematic representations of allocations of display segments of game non-specific information according to the present invention.

FIGS. 12A and 12B are schematic representations of allocations as in FIG. 11C, wherein each shows a different play stop and play restart scenario according to the present invention per FIGS. 2A and 3A, respectively.

### DESCRIPTION OF THE PREFERRED EMBODIMENT

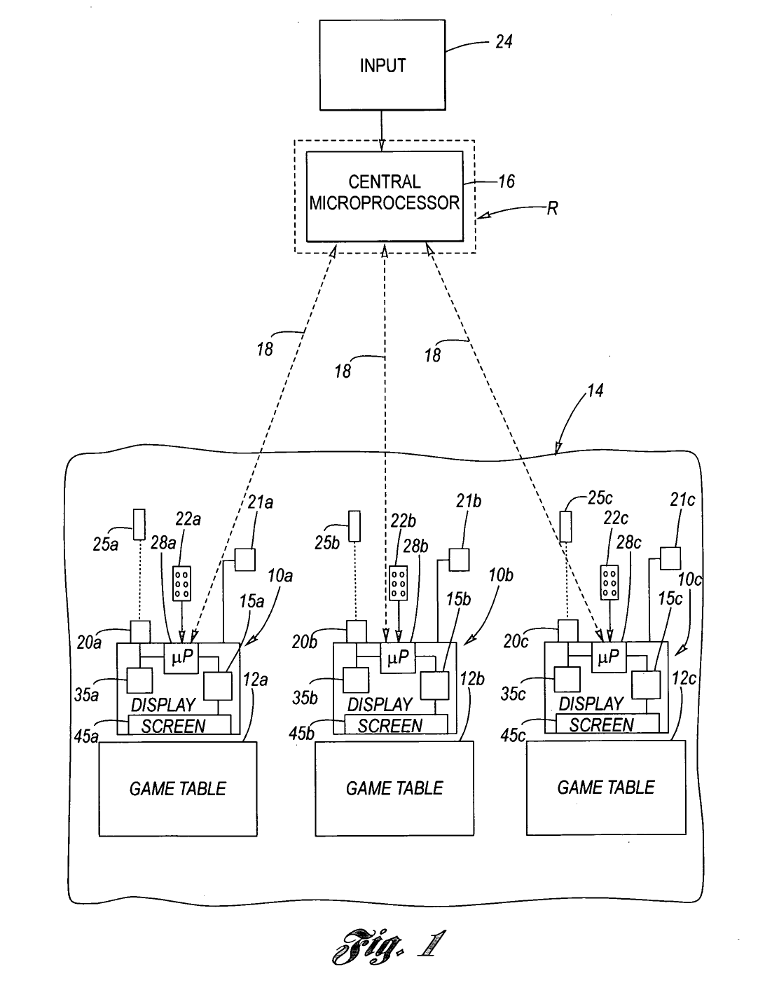

Referring now to the Drawings, FIG. 1 depicts a general exemplification of a system and implementation of a method for the dynamically changeable casino signage messaging according to the present invention, wherein provided are any number of dynamically changeable casino game signage displays 10a, 10b, 10c for a plurality of casino game tables 12a, 12b, 12c, at least one display, respectively, for each game table (for example, a blackjack table may have one display, however a craps table may have two displays, one at each wing, respectively), across a casino gaming floor 14, wherein three displays and three casino game tables are merely an exemplification for illustration, as the number of displays and game tables is unlimited. The displays 10a, 10b, 10c display information that is dynamically interchangeable between game specific information and game non-specific information responsive to the status of play of the game at the respective game tables 12a, 12b, 12c. In this regard, the term “game specific information” means any information related to the game, including by way of illustration, but not limitation, the game title, the game betting limits, rules of play of the game, and identification of the casino or other facility whereat the game is played; and the term “game non-specific information” means any information unrelated to the game, including by way of illustration, but not limitation, advertisements, casino facilities information, announcements, and entertainment. It is to be understood that identification of the casino or other facility whereat the game is played can be considered game non-specific information, as well as being game specific information. In this regard further, when the status of play of the game is “inactive”, there are, for non-limiting example, three possible types of game play inactivity: the game play may be “closed”, wherein the game table is closed for playing of the game; the game play may be “idle”, wherein the game table is open for playing of the game but no one is presently playing; or, the game play may be “paused”, wherein the game is in play but paused as for example during a dealer's cards shuffle procedure, between the end of play of one game and the start of the next.

By way only of illustrative example, a central microprocessor 16 is provided with its microprocessor programming and its display information, wherein the central microprocessor is located at a remote location R of the casino. Each display 10a, 10b, 10c, has a respective microprocessor (μP) 28a, 28b, 28c, which is electronically connected to the central microprocessor 16, as for example by direct wire, but is more preferably by wireless transmission 18, wherein the wired or wireless transmission is most preferably two-way between the central microprocessor and each microprocessor of the displays.

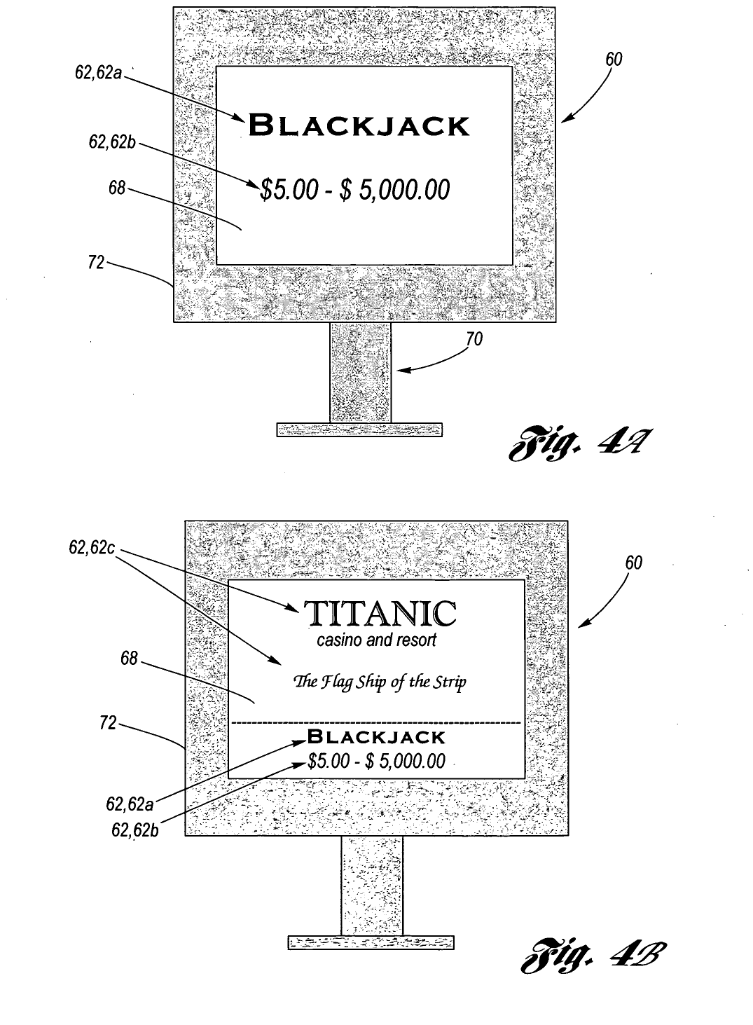

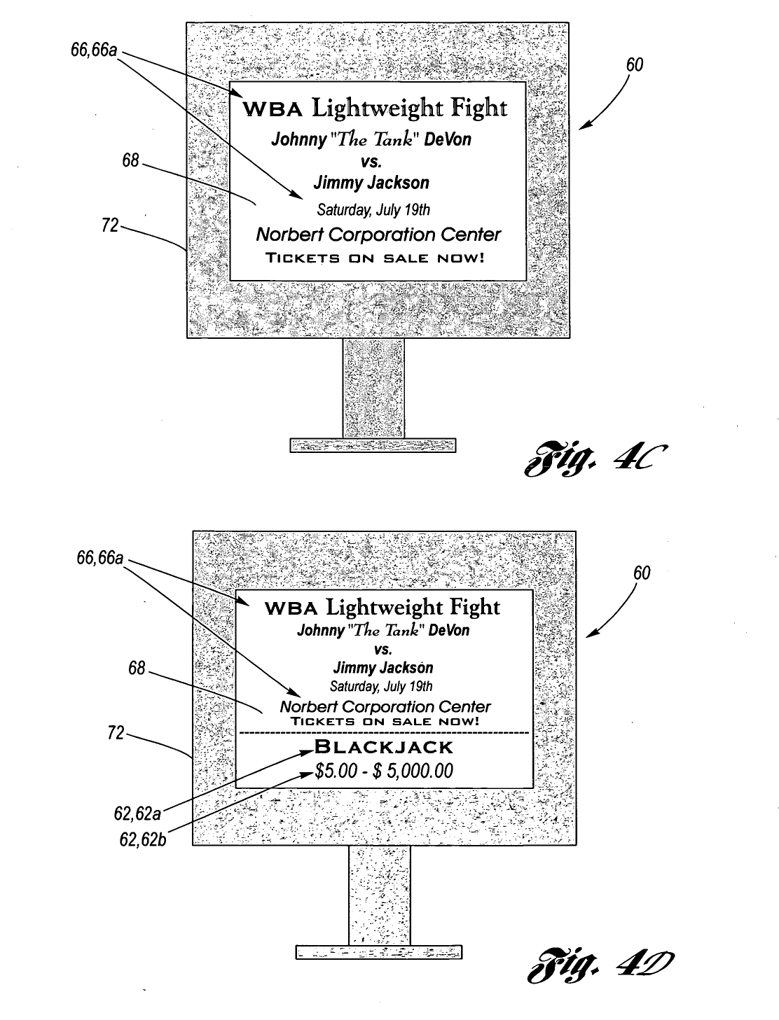

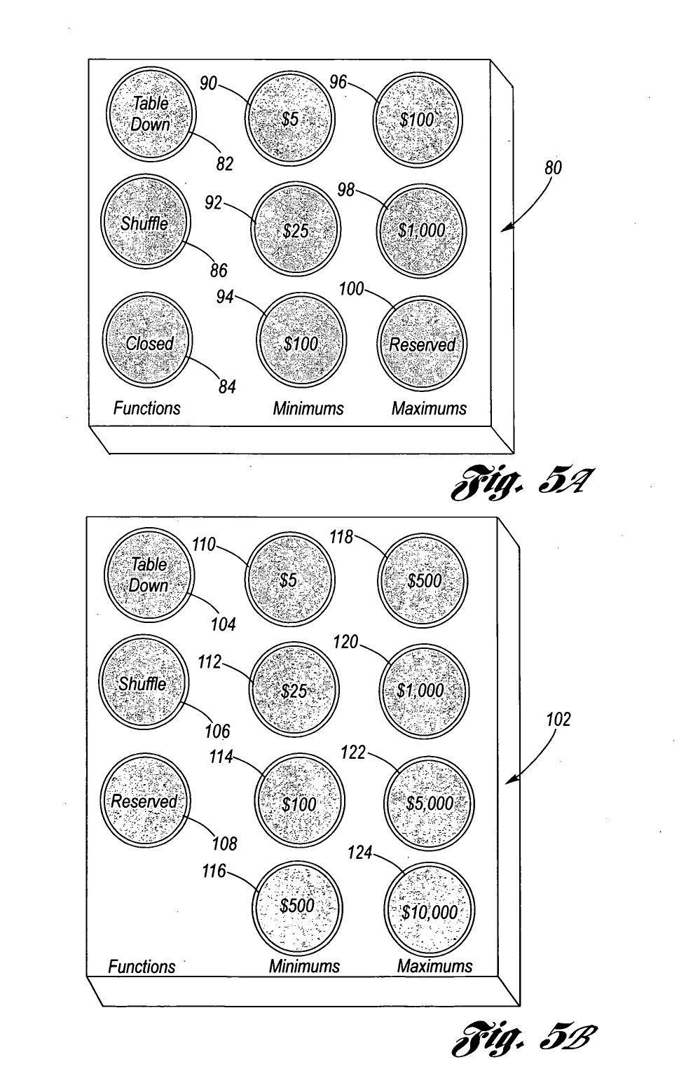

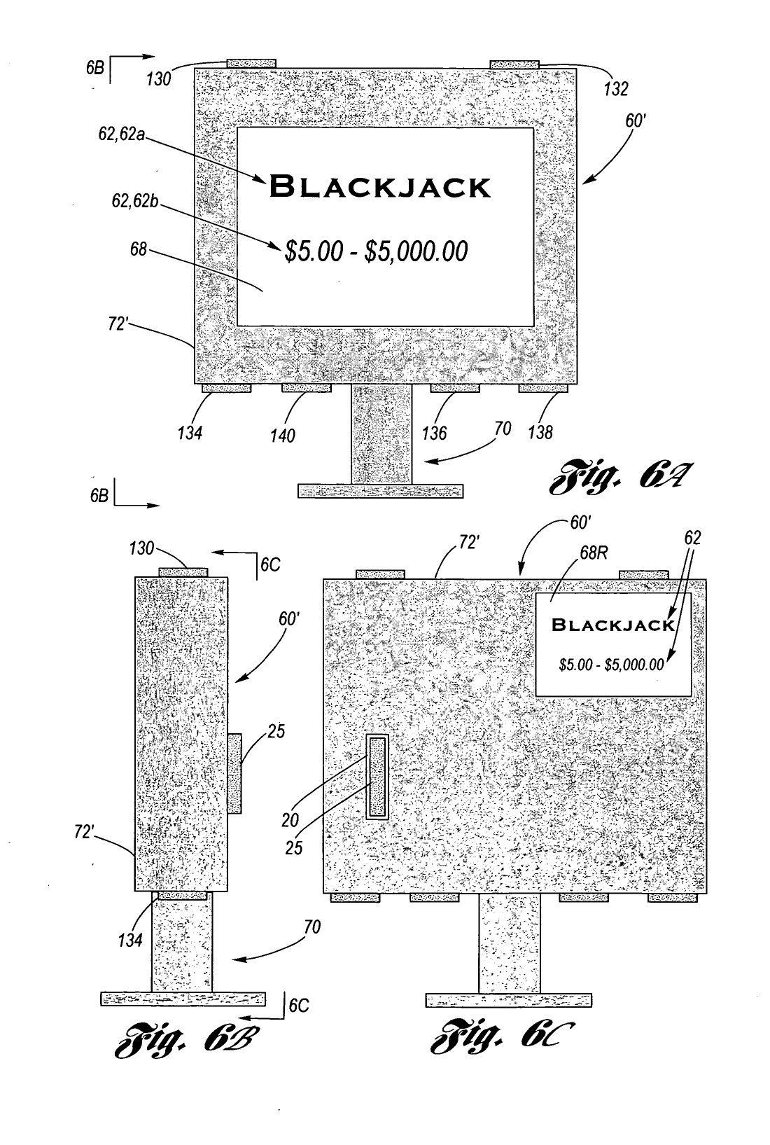

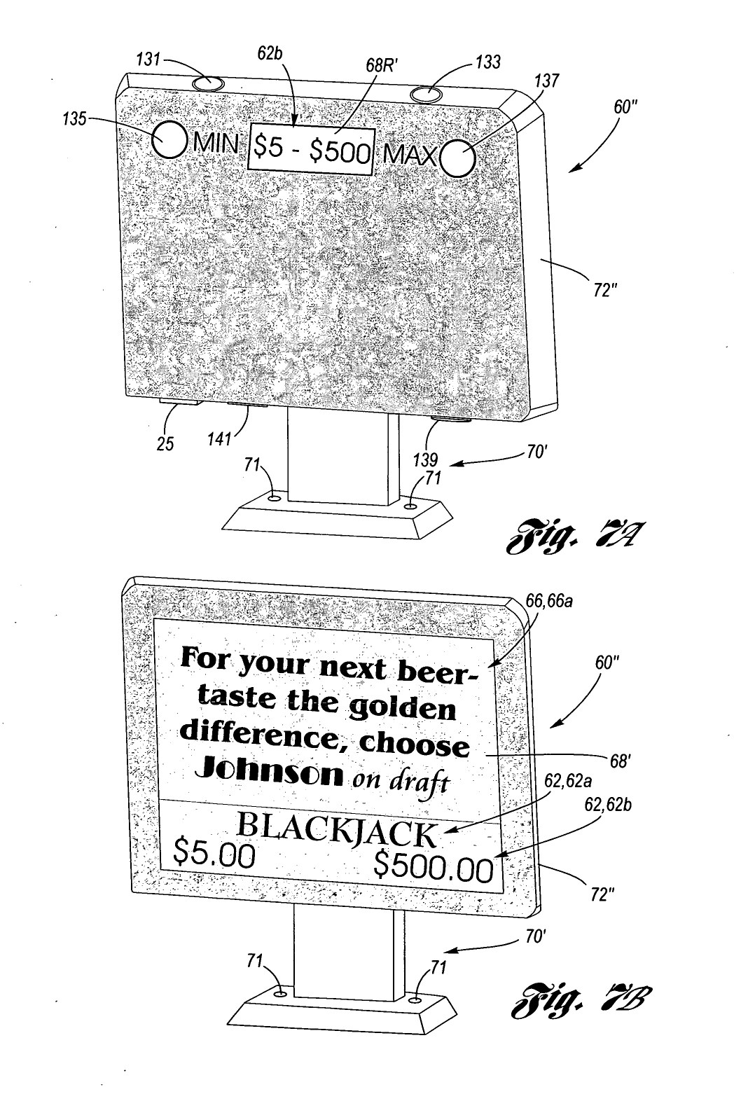

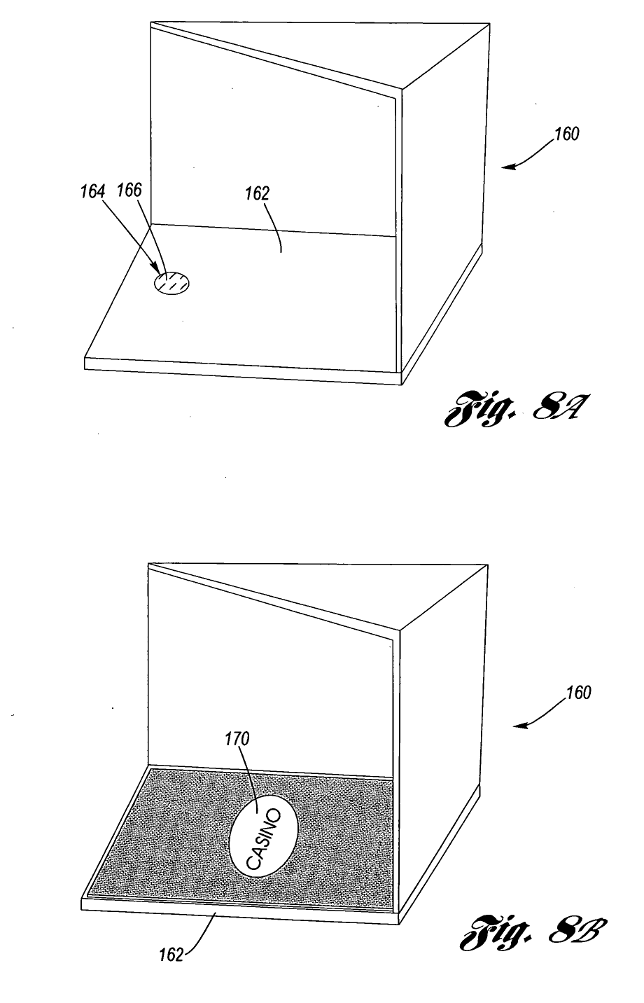

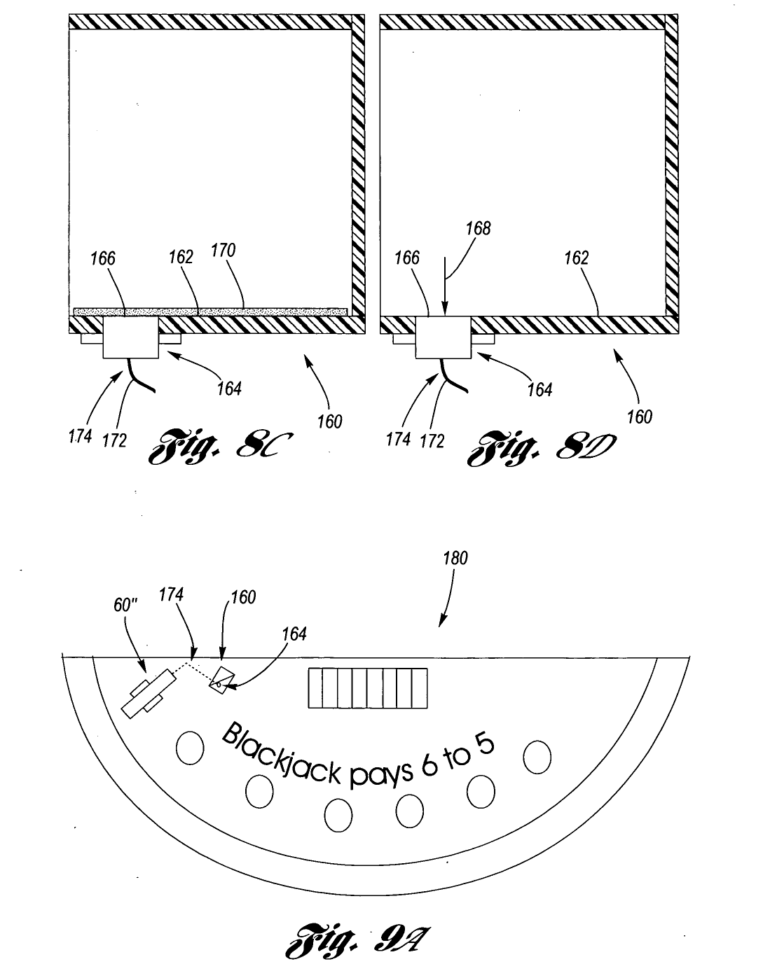

Each display 10a, 10b, 10c preferably includes, for receiving microprocessor programming and display information, at least one data port 20 (see FIG. 6C) and, preferably, an electronic (wireless) communication component, as for example resident in an electronic interface 15a, 15b, 15c. For example, microprocessor programming and display information (ie., game specific and game non-specific information) may be based upon data stored in a removable data storage device 25a, 25b, 25c, as for example a laptop computer with a data transfer cable, a CD/DVD disk, a USB flash memory drive, etc., most preferably a flash memory card 25 (see an example at FIGS. 6C and 7A), being inserted into each respective data port 20a, 20b, 20c, which may be, for example, a CD/DVD drive port or an SD card port or other flash card port, or a USB port. The microprocessor programming and the display information may remain on the data storage device and/or may be uploaded to an internal data storage device 35a, 35b, 35c within the display, for example, a hard drive, flash memory, or microprocessor memory. The microprocessor programming and/or the display information are periodically changed by inserting into each respective data port a new data storage device having new or revised microprocessor programming and/or display information stored therein, and may also be changed remotely by wired or wireless communication from the central microprocessor 16; and/or by an operator (ie., dealer or casino personnel) manually via keys of a keypad 22a, 22b, 22c, or via keys on the display, itself (see FIGS. 6A through 7B); and/or via an automatic status of play of the game detector 21a, 21b, 21c, as for example discussed hereinbelow with respect to FIGS. 8A through 9B.

By way of exemplification, microprocessor programming and the display information for each of the displays is generated at one or more sources, such as an information technology facility and/or a video production facility, wherein the display information is in the form of game specific information and game non-specific information. The microprocessor programming and display information are input to an input interface 24 to the central microprocessor 16 and/or to each of the displays directly via, for example, the data storage devices 25a, 25b, 25c being inserted into the data ports 20a, 20b, 20c.

Each electronic display 10a, 10b, 10c is located at its respective casino game table 12a, 12b, 12c (at least one display per table), preferably game tables throughout the casino floor 14. The game tables 12a, 12b, 12c may be for a variety of games, as for a non-limiting example blackjack tables, roulette tables, baccarat tables, craps tables, etc. The display screen may be provided by any suitable display technology, as for example a CRT or most preferably a plasma or LCD display screen. Each display, preferably and by way of example, includes an internal electronic interface 15a, 15b, 15c which drives the display screen in response to an output from its respective microprocessor, and, in the case of wireless connection 18, includes a wireless communication component for reception (and preferably transmission) between it and/or the respective microprocessor of the display and the central microprocessor.

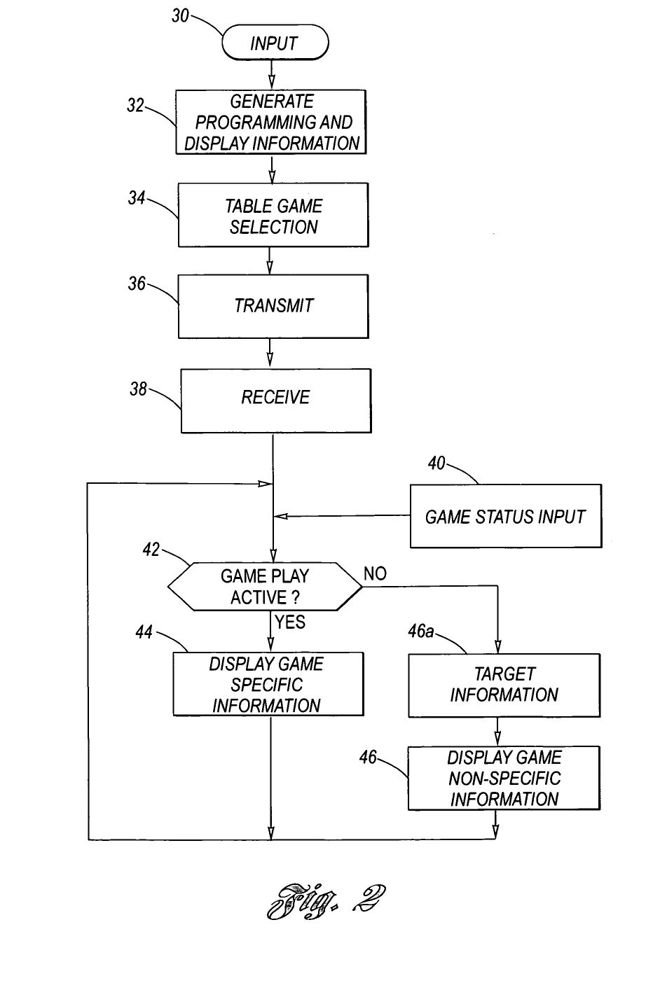

Referring now to FIGS. 2 and 2A, depicted is a first example of algorithms for implementing the method according to the present invention, wherein a central microprocessor is present.

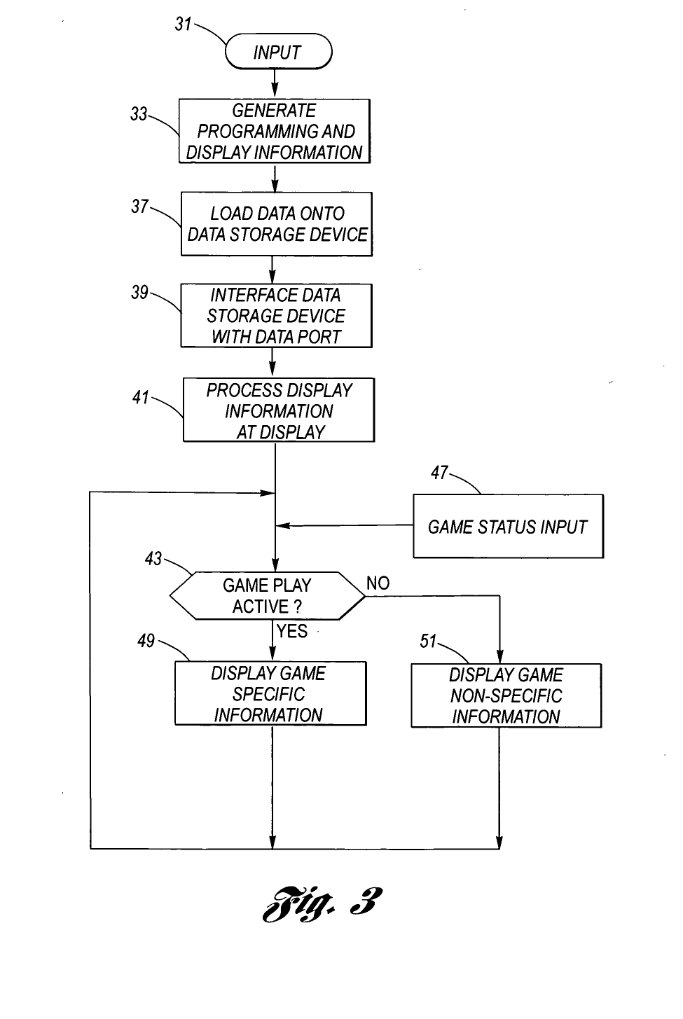

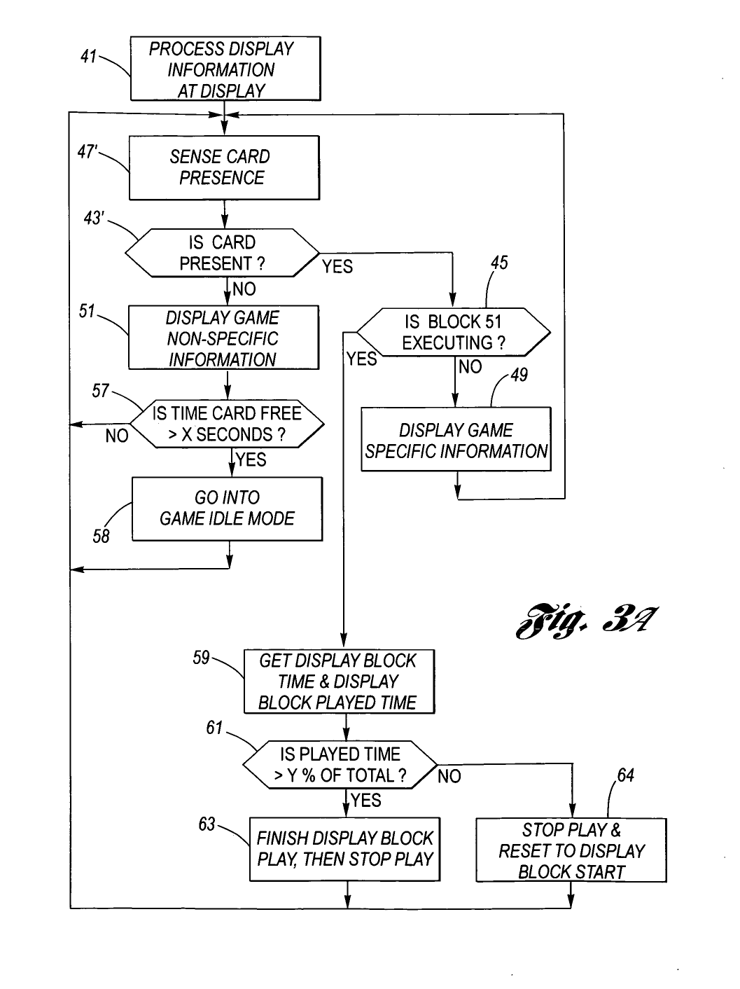

At Block 30 of FIG. 2, microprocessor programming and the display information for each of the displays is generated at one or more sources, such as an information technology facility and/or a video production facility, wherein the display information is in the form of game specific information and game non-specific information, and delivered to the input interface 24. At Block 32, the central microprocessor 16 generates the appropriate display information for each display, respectively. At Block 34, the central microprocessor pairs, according to its microprocessor programming, each display to its respective microprocessor programming and display information, provided, for example, by two-way recognition of an identification code, such as a unique alpha-numeric sequence, with respect to each display. At Block 36, the central microprocessor transmits the display information and any appropriate microprocessor programming for the displays. At Block 38 each individual display 10a, 10b, 10c receives its own specific display information and appropriate microprocessor programming. At Block 40, the status of play of the game is determined, as for example by a dealer input, using keys, for example on the keypad 22, the status of play of the game. Block 40 may also be an automatic status of play of the game detector, an example of implementation of which is shown at FIG. 2A. At Decision Block 42, inquiry is made by the microprocessor within the display whether the play of the game play is active or inactive, and if inactive, whether the play is closed, idle or paused. If the status of play of the game is active, then at Block 44, the microprocessor causes the electronic interface to display game specific information. This is exemplified at FIGS. 4A and 4B, whereat a display 60 displays at its screen 68 game specific information 62, for example in the form of the name of the game or type of game 62a, the dollar betting limits 62b of the game, and casino identification 62c whereat the game is situated. If the status of play of the game is inactive, then at Block 46, the microprocessor of the display causes the electronic interface to display at the screen 68 game non-specific information as exemplified at FIGS. 4C and 4D. In this regard, if the game play inactivity is because the game play is closed, then it is preferred for the display 60 to now display only the game non-specific information 66, 66a, for example an advertisement 66a as exemplified at FIG. 4C; however, if the game play inactivity is because the game play is idle or paused, then it is preferred for the display to then display both game specific information 62, 62a, 62b and game non-specific information 66, 66a, as exemplified at FIG. 4D, wherein it is preferred to continuously display the game specific information, and wherein the game specific information may be correlated to the type of game play inactivity (for example, a certain period of game play idleness may trigger information to be displayed which would induce players to play, ie, lower betting limits). It is preferred to provide the game non-specific information to be tailored for displaying based upon predetermined factors, for example, the game specific information (ie., the game bet minimums/maximums), the game location, or the game type so as to target the information to patrons at the game table; this can be accomplished by the central microprocessor 16 at Block 34 or by the microprocessor 28a, 28b, 28c at each display, respectively, via (optional) Block 46a. The execution of Decision Block 42 by each microprocessor 28a, 28b, 28c can be accomplished in conjunction with two-way communication 18 with the central microprocessor 16, wherein status of play of the game is communicated by the respective microprocessor to the central microprocessor, whereupon the central microprocessor sends thereto appropriate game non-specific information to be displayed.

Turning attention now to FIG. 2A, the algorithm of FIG. 2 is modified, after Block 38, to include an automatic status of play of the game detector, which detector, merely by way of exemplification is a card presence/absence detector, and which detector can be another game play article detector.

After Block 38, the status of play of the game is sensed at Block 40′ by the status of play of the game detector 21a, 21b, 21c (implemented, by nonlimiting example, as discussed hereinbelow with respect to FIGS. 8A through 9B). At Decision Block 42′, inquiry is made by the microprocessor within the display using the sensed information from Block 40′ whether the status of play of the game play is active or inactive (card present means status of play is active, card not present means status of play is inactive).

If the answer to the inquiry at Decision Block 42′ is no, meaning status of play of the game is inactive (because for nonlimiting example, no card is present ie., a card is absent at a discard rack), then, after optional Block 46a, at Block 46 the microprocessor of the display causes the electronic interface to display at the screen 68 game non-specific information in the manner as discussed above. With regard to optional Block 46a, as mentioned above, it is preferred to provide the game non-specific information to be tailored for displaying based upon predetermined factors, for example, the game specific information (ie., the game bet minimums/maximums), the game location, or the game type so as to target the information to patrons at the game table; this can be accomplished by the central microprocessor 16 at Block 34 or by the microprocessor 28a, 28b, 28c at each display, respectively, via (optional) Block 46a. The execution of Decision Block 42′ by each microprocessor 28a, 28b, 28c can be accomplished in conjunction with two-way communication 18 with the central microprocessor 16, wherein status of play of the game is communicated by the respective microprocessor to the central microprocessor, whereupon the central microprocessor sends thereto appropriate game non-specific information to be displayed. The program then advances to Decision Block 50.

At Decision Block 50 inquiry is made as to whether a card has been absent from the discard rack for in excess of a predetermined time, as for example greater than 300 seconds. If the answer to the inquiry at Decision Block 50 is no, then the program returns to Block 40′. However, if the answer to the inquiry is yes, then the program advances to Block 52, whereat a game idle subroutine commences to run. This subroutine may, for example, cause the microprocessor to display game non-specific information (which may also include game specific information) based upon the play of the inactive game status now being changed from paused to idle, and may further include causing the microprocessor to invert the displayed information at the rear of the display so as to serve as an alert to casino personnel of the extended duration of inactivity of the game; and/or may cause the microprocessor to initiate, after a predetermined time of card absence, as for example 30 minutes, reduction in the game limits to thereby attract players to the game table.

As mentioned, if the game play inactivity is because the game play is idle or paused, then it is preferred for the display to then display both game specific information 62, 62a, 62b and game non-specific information 66, 66a, as exemplified at FIG. 4D, wherein it is preferred to continuously display the game specific information, and wherein the game specific information may be correlated to the type of game play inactivity (for example, a certain period of game play idleness may trigger information to be displayed which would induce players to play, ie, lower betting limits).

However, if the answer to the inquiry at Decision Block 42′ is yes, meaning the status of play of the game is active because a card is present, then at Decision Block 35 inquiry is made whether Block 46 is already executing. If the answer to this inquiry is no, then at Block 44, the microprocessor causes the electronic interface to display at the screen 68 game specific information, in the manner as discussed above, and the program returns to Block 40′.

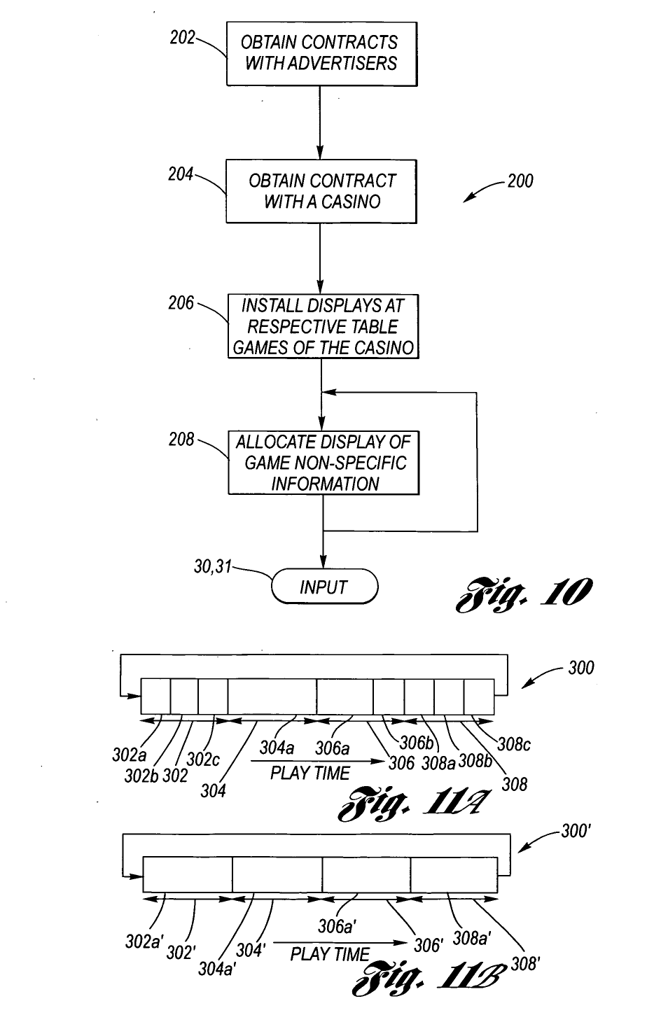

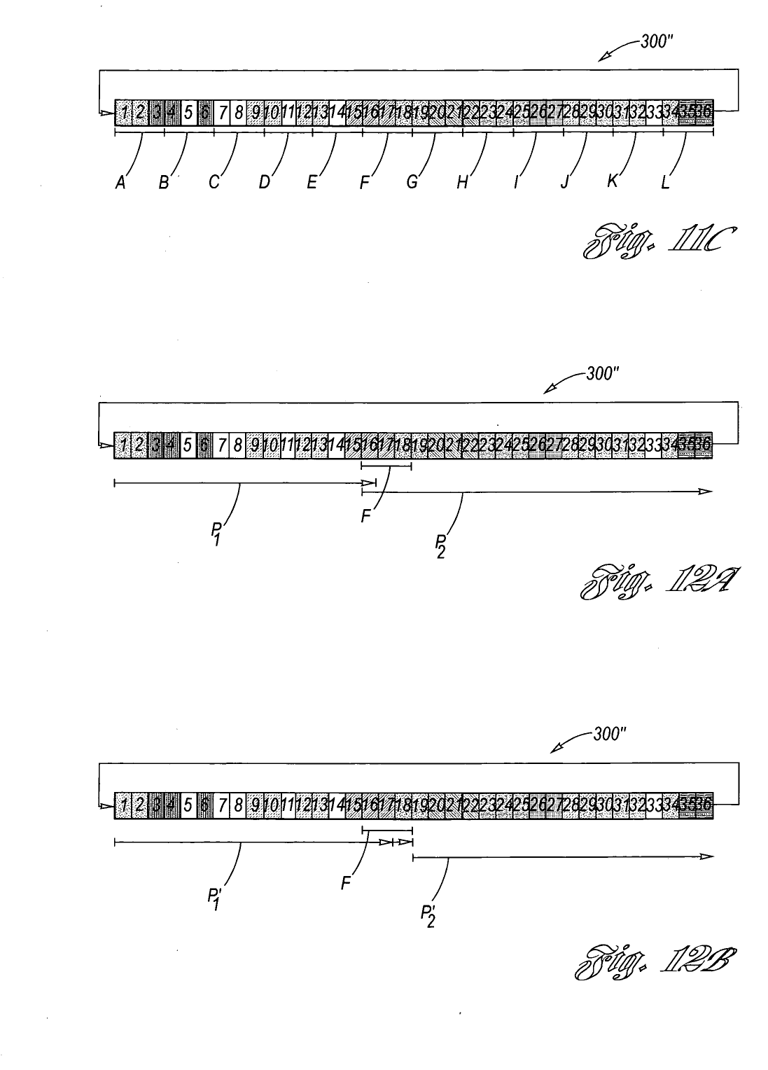

However, if the answer to the inquiry at Decision Block 35 is yes, this means the status of the game has now gone from inactive to active, and the display of game non-specific information is to now terminate to be substituted by game specific information. The program now advances to Block 53, whereat the total play time of the displayed display block of the game non-specific information and the current play (ie., already played) time thereof is obtained. By way of preferred example, a display block has a duration of 24 seconds which approximates an average card shuffle time, and is composed of three 8 second display segments (discussed below with regard to FIGS. 11A through 12B). The program then advances to Decision Block 54.

At Decision Block 54, inquiry is made whether the current time of play exceeds a predetermined percent of the total play time of the display block, as for example play time greater than 50 percent of total display block play time (see hereinbelow discussion with respect to FIGS. 12A and 12B). If the answer to the inquiry is yes, then at Block 55 the program causes the microprocessor to finish play of the display block, then stop play of the display block (see FIG. 12A), ready the start of the next play of the game non-specific information at the next scheduled display block, and then returns to Block 40′. If the answer to the inquiry is no, then at Block 56 the program causes the microprocessor to stop play of the display block, ready restart for the next display of the game non-specific information at the beginning of the display block that was in play (see FIG. 12B), and then returns to Block 40′.

According to the first example of the algorithm for implementing the method of the present invention, the microprocessor programming and display information are dynamically changed at the remote location R via the central microprocessor 16, but may be dynamically changed at the display, or both. For example, at the remote location R the microprocessor programming and the display information in the form of both game specific and game non-specific information are input to the central microprocessor and selectively sent wirelessly to the displays throughout the casino. In this regard, some displays may receive different display information depending, for example, upon location of game tables in the casino, or other criteria. Additionally, or alternatively, authorized casino personnel (ie., a dealer) may program the microprocessor of the display at his/her game table using the various keys thereat, as for example to switch between game specific and game non-specific information based upon, for example, the status of play of the game at the game table. Additionally or alternatively, an automatic status of play of the game detector 21a, 21b, 21c, as for example a card presence detector interfaced with a discard rack, may provide automatic switching between display of game specific and game non-specific information responsive to the detected status of play of the game. Additionally or alternatively further, the microprocessor programming and the display information (ie., the game specific and game non-specific information) may be data stored in a laptop computer and downloaded through a link (ie., USB data cable) to the data port, or be data stored in a removable data storage device such as a flash memory card, etc., which is inserted into the data port.

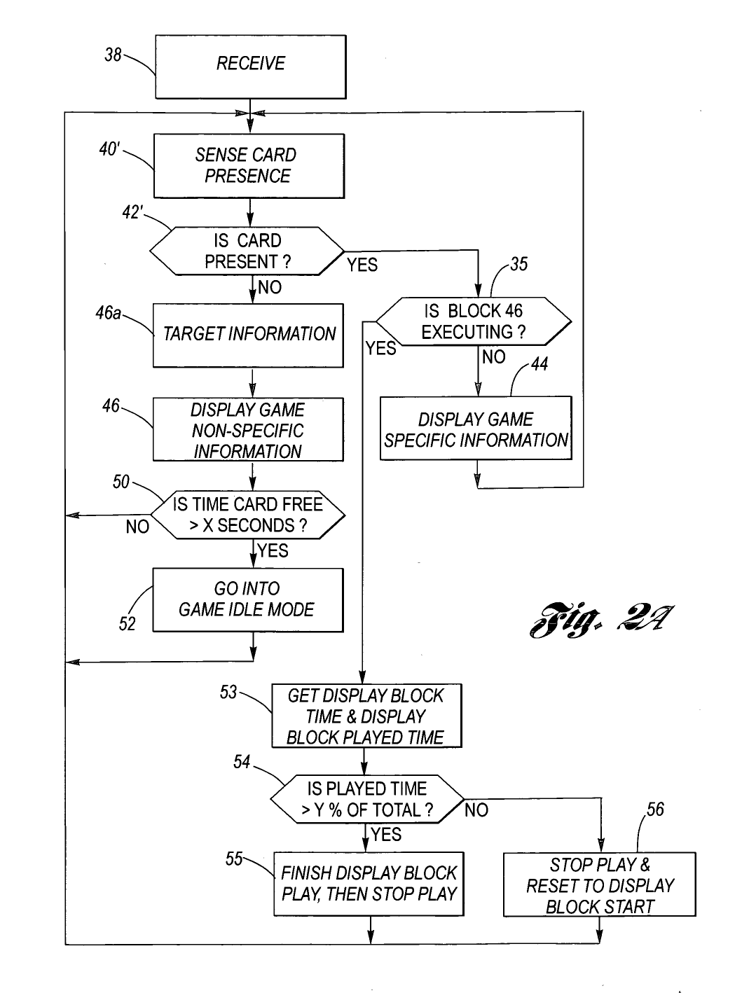

Referring now to FIGS. 3 and 3A, depicted is a second example of algorithms for implementing the method according to the present invention, wherein there is no central microprocessor.

At Block 31 of FIG. 3, microprocessor programming and display information are obtained at one or more sources, such as an information technology facility and/or a video production facility, wherein the display information is in the form of game specific information and game non-specific information. At Block 33, the microprocessor programming and the display information, which is both game specific and game non-specific, are generated for each display, respectively. At Block 37, the microprocessor programming and the display information are loaded as data onto a data storage device, as for example a laptop computer, a CD/DVD disk, a USB flash memory drive, etc., most preferably a flash memory card. At Block 41, the data storage device is connected to the data port of a selected display. In this regard, for example, a particular data storage device is paired to a particularly selected display based upon selection criteria, as for example the type of game, game bet limits, game table location, etc. Further for example, the programming within the display may automatically select particularly selected display from a generic range of display information based upon selection criteria, as for example game type, game bet limits and game location. At Block 41, the microprocessor within the display uses the microprocessor programming to process the display information as displayable game specific and/or game non-specific information at the display. At Block 47, the status of play of the game is determined, as for example by dealer input, using keys of the display or a keypad wirelessly or wiringly connected with the display, the status of play of the game. Block 47 may also be an automatic status of play of the game detector, the implementation of which is shown at FIG. 3A. At Decision Block 43, inquiry is made by the microprocessor within the display whether the game play is active or not, which may include inquiry as to the type of inactivity. If the status of play of the game is active, then at Block 49, the microprocessor causes the electronic interface to display game specific information. This is exemplified at FIGS. 4A and 4B, whereat a display 60 displays at the screen 68 game specific information 62 in the form for example of the name of the game 62a, the dollar betting limits 62b of the game, and casino identification 62c whereat the game is situated. If the status of play of the game is inactive, then at Block 51, the microprocessor causes the electronic interface to display at the display 68 game non-specific information, as exemplified at FIGS. 4C and 4D. As mentioned above, if the game play inactivity is because the game play is closed, then it is preferred for the display 60 to now display only game non-specific information 66, 66a, for example an advertisement 66a as exemplified at FIG. 4C; however, if the game play inactivity is because the game play is idle or paused, then it is preferred to show both game specific information 62, 62a, 62b and game non-specific information 66, 66a, as exemplified at FIG. 4D, wherein it is preferred to continually display the game specific information, and wherein the game specific information may be correlated to the type of game play inactivity (for example, a certain period of game play idleness may trigger information to be displayed which would induce players to play, ie, lower betting limits).

Turning attention now to FIG. 3A, the algorithm of FIG. 3 is modified, after Block 41, to include an automatic status of play of the game detector, which detector, merely by way of exemplification is a card presence/absence detector, and which detector can be another game play article detector.

After Block 41, the status of play of the game is sensed at Block 47′ by the status of play of the game detector 21a, 21b, 21c (implemented, by nonlimiting example, as discussed hereinbelow with respect to FIGS. 8A through 9B). At Decision Block 43′, inquiry is made by the microprocessor within the display using the sensed information from Block 47′ whether the play of the game play is active or inactive (card present means status is active, card not present means status is inactive).

If the answer to the inquiry at Decision Block 43′ is no, meaning status of play of the game is inactive (because, for nonlimiting example, no card is present, ie., a card is absent at the discard rack), then at Block 51 the microprocessor of the display causes the electronic interface to display at screen 68 game non-specific information in the manner discussed above. As mentioned above, it is preferred to provide the game non-specific information to be tailored for displaying based upon predetermined factors, for example, the game specific information (ie., the game bet minimums/maximums), the game location, or the game type so as to target the information to patrons at the game table. The program then advances to Decision Block 57.

At Decision Block 57 inquiry is made as to whether a card has been absent from the discard rack for in excess of a predetermined time, as for example greater than 300 seconds. If the answer to the inquiry at Decision Block 57 is no, then the program returns to Block 47′. However, if the answer to the inquiry is yes, then the program advances to Block 58, whereat a game idle subroutine commences to run. This subroutine may, for example, cause the microprocessor to display game non-specific information (which may also include game specific information) based upon the play of the inactive game status being now being changed from paused to idle, and may further include causing the microprocessor to invert the displayed information at the rear of the display so as to serve as an alert to casino personnel of the extended duration of inactivity of the game; and/or may cause the microprocessor to initiate, after a predetermined time of card absence, as for example 30 minutes, reduction in the game limits to thereby attract players to the game table.

As mentioned, if the game play inactivity is because the game play is idle or paused, then it is preferred for the display to then display both game specific information 62, 62a, 62b and game non-specific information 66, 66a, as exemplified at FIG. 4D, wherein it is preferred to continuously display the game specific information, and wherein the game specific information may be correlated to the type of game play inactivity (for example, a certain period of game play idleness may trigger information to be displayed which would induce players to play, ie, lower betting limits).

However, if the answer to the inquiry at Decision Block 43′ is yes, meaning the status of play of the game is active because a card is present, then at Decision Block 45 inquiry is made whether Block 51 is already executing. If the answer to this inquiry is no, then at Block 49, the microprocessor causes the electronic interface to display at the screen 68 game specific information, in the manner as discussed above, and the program returns to Block 47′.

However, if the answer to the inquiry at Decision Block 45 is yes, this means the status of the game has now gone from inactive to active, and the display of game non-specific information is to now terminate to be substituted by game specific information. The program now advances to Block 59, whereat the total play time of the displayed display block of the game non-specific information and the current play (ie., already played) time thereof is obtained. (As mentioned, a preferable display block has a duration of 24 seconds which approximates an average card shuffle time, and is composed of three 8 second display segments, per FIGS. 11A through 12B). The program then advances to Decision Block 61.

At Decision Block 61, inquiry is made whether the current time of play exceeds a predetermined percent of the total play time of the display block, as for example play time greater than 50 percent of total display block play time (see hereinbelow discussion with respect to FIGS. 12A and 12B). If the answer to the inquiry is yes, then at Block 63 the program causes the microprocessor to finish play of the display block, then stop play of the display block (see FIG. 12A), ready the start of the next play of the game non-specific information at the next scheduled display block, and then returns to Block 47′. If the answer to the inquiry is no, then at Block 64 the program causes the microprocessor to stop play of the display block, ready restart for the next display of the game non-specific information at the beginning of the display block that was in play (see FIG. 12B), and then returns to Block 47′.

According to the second example of the algorithm for implementing the method of the present invention, the displaying of the display information is dynamically changed at the display. For example, microprocessor programming and the display information (ie., game specific information and game non-specific information) are stored in a data storage device which is then physically delivered to each display, via, for example, the data port thereof, throughout the casino. In this regard, some displays may receive different display information depending, for example, upon location of game tables in the casino or other criteria. The microprocessor of each display would then utilize its microprocessor programming to appropriately cause display of its respective display information so as to selectively display the game specific and the game non-specific information. Additionally, or alternatively, authorized casino personnel (ie., a dealer) may change the display information and/or the microprocessor programming of the display at his/her game table using the various keys thereat, as for example to switch between game specific and game non-specific information based upon, for example, the status of play of the game at the game table, as well as certain game specific information, such as the dollar betting limits of the table game. Additionally or alternatively, an automatic status of play of the game detector 21a, 21b, 21c, as for example a card presence detector interfaced with a discard rack, may provide automatic switching between display of game specific and game non-specific information responsive to the detected status of play of the game.

It is possible, though not as preferred as the processes represented by FIGS. 2A and 3A, to alter the process steps in FIGS. 2A and 3A such that if the answer to the inquiry at Decision Block 42′ or 47′, respectively, is no, then at Block 46 or 51, respectively, the display of the game non-specific information is for a predetermined set duration, as for example a typical card shuffle time of 24 seconds, which time preferably correlates to a complete play of a display block. By way of example, FIG. 3B is a modification of FIG. 3A to implement the predetermined set duration of play of the game non-specific information, wherein a similar modification of FIG. 2A is analogously possible, but not shown for brevity, and it is to be understood that other game play article detectors may instead be implemented therewith.

Presence of a card is sensed at Block 47′, and the program advances to Decision Block 43″ whereat inquiry is made as to whether a card is present at the discard rack. If the answer to the inquiry at Decision Block 43″ is yes, then the program inquires at Decision Block 58′ whether the game is in idle mode, wherein if the answer to the inquiry is no, the program advances to Decision Block 57 whereat inquiry is made whether a time the card is absent from the discard rack exceeds a predetermined time, as for example 300 seconds. If the answer to the inquiry is no, then at Block 49 the microprocessor causes to be displayed at the display 68 game specific information, and the program returns to Block 47′.

However, if the answer to the inquiry at Decision Block 43′ is no, then the program advances to Decision Block 45′ whereat inquiry is made whether Block 51 has recently executed preferably within the time specified in Decision Block 57 (ie., 300 seconds). If the answer to the inquiry is no, then the program advances to Block 51′, whereat the microprocessor causes display of game non-specific information for a preset time, as for example an average card shuffle time of 24 seconds, whereupon program advances to Decision Block 57, wherein the answer to the inquiry will be no, so the program will advance to Block 49. At Block 49 the microprocessor commences display of game specific information, and returns to Block 47′. In this regard, since the timing of execution of Block 51′ matches the timing of a whole display block, the switch from game non-specific information to game specific information is immediate. Now, if a card is present at Block 47′, the program will advance through Decision Blocks 43″, 58′ and 57 so that Block 49 continues executing as long as a card remains present at the discard rack. On the other hand, if a card is not present at Block 47′, then the program will advance through Decision Block 43″ to Decision Block 45′, whereat the answer to the inquiry will be yes, and the program will advance through Decision block 57, and, as long as the inquiry thereat is no, then on to Block 49, wherein the game specific information will continue to play even though no card is present in the discard rack. However, if the duration of card absence from the discard rack exceeds the predetermined time (ie., the above mentioned 300 seconds), then at Block 57 the answer to the inquiry will be yes, and the program will then divert to Block 58, whereat the program goes into game idle mode, the nature of which is discussed hereinabove, and the program then returns to Block 47′.

Execution of Block 58 will continue until presence of a card is sensed at Block 47′, whereupon the program advances through Decision block 43″ to Decision Block 58′, whereat the answer to the inquiry of whether the game idle mode is executing will be yes. The program then advances through to Block 59, Decision Block 61 and one of Block 63 or 64, the nature of which is detailed hereinabove, and the program then returns to block 47′.

It will be understood, in summary, that in the method of carrying out the present invention displaying, selectively, at least one of the game specific information and the game non-specific information at the display is related to the status of play of the game at the game table. For example, when the status of play of the game at the game table is “inactive”, there are, for non-limiting example, three possible types of game play inactivity: the game play may be “closed”, wherein the game table is closed for playing of the game; the game play may be “idle”, wherein the game table is open for playing of the game but no one is presently playing; or, the game play may be “paused”, wherein the game is in play but paused as for example during a dealer's cards shuffle procedure, between the end of play of one game and the start of the next. When the status of play of the game is inactive, the microprocessor programming causes to be displayed at the display the game non-specific information, but also causes to be displayed the game specific information if the game play inactivity is due to the game play being idle or paused, wherein the display information displayed may be correlated to the type of game play inactivity (for example, if the game play inactivity is due to the game play being closed, preselected non-game specific information may then be displayed which is appropriate to a long duration of game play inactivity). When the status of play of the game is active (ie., the game is actively in play), the microprocessor programming causes to be displayed at the display, preferably only, the game specific information. The display information displayed may be in static format and/or may be in moving picture format (ie., video, streaming video, etc.), and may or may not include sound.

The preferred displays 60, 60′, 60″, are shown at FIGS. 4A through 4D, at FIGS. 6A through 6C, and, most preferably, at FIGS. 7A and 7B. The preferred display screen 68, 68′ uses plasma or most preferably LCD technology, well known in the art. A stand 70 may be pivotally and swivelably connected to a housing 72, 72′, but for simplicity the stand 70′ is more preferably fixedly connected to the housing 72″. Preferred dimensions for the display 60, 60′ of FIGS. 4A through 4D and 6A through 6C are: the display screen 68, 68′ is about 6.5 inches diagonally, the housing 72, 72′ is about 6 inches wide, 7 inches high and about 0.5 inches deep, and the stand 70 is about 1 inch high, wherein the stand may include screw holes for mounting to a selected surface on or around the table. Preferred dimensions for the most preferred display 60″ of FIGS. 7A and 7B are: the display screen 68′ is about 8.5 inches diagonally, the housing 72″ is about 8.75 inches wide, 8 inches high and about 1.75 inches deep, and the stand 70′ is about 2 inches high, wherein the stand includes screw holes 71 for mounting to a selected surface on or around the table.

It is preferred for an indication of the content of the display information being displayed at the display screen 68, 68′ to be visible at the rear of the display 60′, 60″ so that pit personnel can, at a glance, know this content (particularly betting limits). In this regard, comparing FIG. 6A with FIG. 6C, a first preferred mode to present this content at the rear of the display is to utilize a rear display screen 68R, preferably an LCD or plasma screen relatively smaller than the display screen 68, which is electronically connected to the electronic interface of the display (see 15a-15c in FIG. 1) so as to display at the rear display screen 68R all, or a selection portion of, the same game specific information 62 as is displayed at the display screen 68. In this regard further, comparing FIG. 7A with FIG. 7B, a second preferred mode to present this content at the rear of the display is to utilize a rear display screen 68R′, preferably a VFD or LED display screen (or possibly another type of display screen as for example, a LCD or plasma screen) smaller than the display screen 68′, which is electronically connected to the electronic interface of the display (see 15a-15c in FIG. 1) so as to display at the rear display screen 68R′ a selected portion of the same game specific information 62 (ie., the betting limits numbers 62b) displayed at the display screen 68′.

Additionally, FIGS. 6B, 6C, and 7A show a data storage device 25 (a flash memory card) inserted into a data port (see 20 in FIG. 6C).

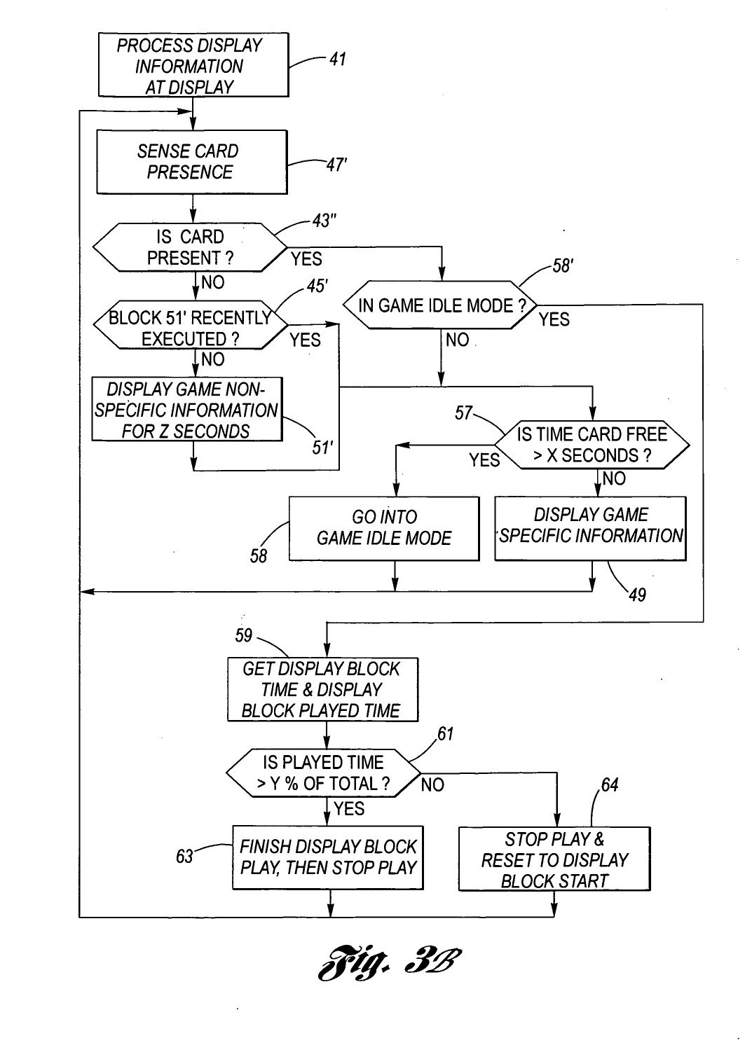

Referring now additionally to FIGS. 5A through 7B operation of keys for implementing Blocks 40, 40′, 47, 47′ of FIGS. 2 through 3A according to the method of the present invention will be detailed, wherein, for the sake of brevity, the algorithm of FIG. 2 will only be referenced with specificity.

Referring firstly to FIG. 5A, a “Type I” keypad 80 has a plurality of keys which are connected to the microprocessor of the display by wire or wirelessly. The normal mode of display is Block 44.

The TABLE DOWN function key 82 is pressed when the game is closed or open, but not active, in which case Block 46 is then operative until the CLEAR function key 84 is pressed. The SHUFFLE function key 86 is pressed when the dealer is shuffling cards or cards are in a shuffle machine or being exchanged, in which case Block 46 is then operative for a predetermined time period whereafter Block 44 is operative. The CLEAR function key 84 is pressed to reset.

Keys are also provided to select a minimum and a maximum dollar bet for the game under Block 44. This may be preset keys or input from a set of alpha-numeric keys.

Each display has a memory so that when the TABLE DOWN or SHUFFLE function keys are pressed, the game minimum and maximum will remain set, as well as in the case of the display being turned off.

Examples of the minimum keys are as follows. A $5 minimum key 90 is pressed when the minimum table limit is $5, $10, $15 or $20, wherein each time the $5 minimum key 90 is pressed the minimum displayed increases in increments of $5, but to revert to a lesser minimum, the CLEAR function key is pressed to reset to zero. A $25 minimum key 92 is pressed when the minimum table limit is $25, $50, or $75, wherein each time the $25 minimum key 92 is pressed the minimum displayed increases in increments of $25, but to revert to a lesser minimum, the CLEAR function key is pressed to reset to zero. A $100 minimum key 94 is pressed when the minimum table limit is $100 and above, wherein each time the $100 minimum key 94 is pressed the minimum displayed increases in increments of $100, but to revert to a lesser minimum, the CLEAR function key is pressed to reset to zero.

Examples of the maximum keys are as follows. A $100 maximum key 96 is pressed when the maximum table limit is between $100 and $1,000, wherein each time the $100 maximum key 96 is pressed the maximum displayed increases in increments of $100, but to revert to a lesser maximum, the CLEAR function key is pressed to reset to zero. A $1,000 maximum key 98 is pressed when the maximum table limit is above $1,000, wherein each time the $1,000 maximum key 98 is pressed the maximum displayed increases in increments of $1,000, but to revert to a lesser maximum, the CLEAR function key is pressed to reset to zero.

A RESERVED function key 100 is pressed when the table is reserved for a very important person, ie., a VIP player, wherein the CLEAR function key is pressed to reset.

Referring now to FIG. 5B, a “Type II” keypad 102 has a plurality of keys which are connected to the microprocessor of the display by wire or wirelessly. The normal mode of display is Block 44.

The TABLE DOWN, SHUFFLE and RESERVED function keys 104, 106, 108 are as described hereinabove with respect to FIG. 4A. However, each of the minimum keys $5 110, $25 112, $100 114, $500 116 and the maximum keys $500 118, $1,000 120, $5,000 122, $10,000 124 are each of fixed face value and not incrementable with successive pressing.

Referring now to FIGS. 6A and 6B, a display 60′ has a display screen 68, and stand 70 as described above, wherein now the housing 72′ includes integrated keys, wherein there is no keypad. The keys operate, by way of example, generally as described above with respect to FIG. 5A, and include a TABLE DOWN function key 130 (operating similarly to key 82), a SHUFFLE function key 132 (operating similarly to key 86), a CLEAR function key 134 (operating similarly to key 84), at least one minimum function key 136 (operating similarly to any or all of keys 90-94), at least one maximum function key 138 (operating similarly to any or all of keys 96-98) and a RESERVED function key 140 (operating similarly to key 100). Keys may be combined or otherwise provided, and may be disposed at other locations of the housing.

Referring now to FIGS. 7A and 7B, which is most preferred, a display 60″ has a display screen 68′, and stand 70′ as described above, wherein now the housing 72″ includes integrated keys, wherein there is no keypad. The keys operate, by way of example, somewhat as generally described above with respect to FIGS. 6A through 6C, having the following aspects. A Table Down (game idle) function key 133 (initiating by way of example display of game non-specific information), a Shuffle (game paused) function key 131 (initiating by way of example display of game non-specific information for a predetermined duration), a minimum bet function key 135 (for scrolling through preset betting minimums), and a maximum bet function key 137 (for scrolling through preset betting maximums). An optional Reserved function may be implemented at the end of scroll of either keys 135 or 137. A game closed key 139, initiating the programming to enter game closed mode and display, preferably, only game non-specific information. Keys may be combined or otherwise provided, and may be disposed at other locations of the housing.

An example of a preferable functionality of the display 60″ is as follows.

The screen 68R′ on the rear of the display 60″ indicates what the minimum amount is at the front screen 68′ of the display. Pressing the minimum bet function key 135 changes the minimum bet amount of the game table. Each time the key 135 is pressed and released the minimum bet amount is increased according to the amounts supplied by the casino. To go down in bet value, the keys 131 and 135 are pressed simultaneously and released for each amount that is to be reduced. The non-game specific information targeting (ie., Block 46a) is based on the minimum bet amount selected.

The screen 68R′ at the rear of the display 60″ indicates what the maximum bet amount is at the front screen 68′ of the display. The maximum bet function key 137 changes the maximum amount on the table. Each time the key 137 is pressed and released the bet maximum is increased according to the amounts supplied by the casino. If the amount is to be lowered, then keys 137 and 133 are pressed simultaneously and released for each amount that is to be reduced.

On the top of the display 60″, closest to the dealer, is the Shuffle function key 131. Once the cards are ready for the shuffle sequence, this key 131 is pressed. The non-game specific information will be displayed for a set duration based on game type. There is no interaction needed for the display 60″ to end its cycle and go back to the game specific information. If necessary the shuffle process can be ended early by pressing either of the keys 131 or 133 at the top of the display 60″.

Also at the top of the display 60″, furthest from the dealer, is the is the Table Down function key 133. Pressing this key 133, the display 60″ continuously displays the game non-specific information while the game sits idle without players. The minimum and maximum bet amounts are also displayed at the bottom of the screen 68′ during this time. The rear screen 68R′ shows the min and max bets inverted to inform casino pit personnel of the idle status of the game. Pressing either of the top keys 131 or 133 will restore display of the game specific information (ie., the game play status has gone from inactive, because the game play is idle, to active).

If the game table is in idle mode (also referable to as “dead game mode”) for 25 minutes, the preset bet limits will drop down one amount. For example, if a game sits idle for 25 minutes and has a $50 minimum, the display will drop the minimum to $25, and at $25 it will not drop to $15 regardless of how long the game sits idle. Prior to when the minimum will drop, the rear screen 68R′ will flash “DROPPING” for 72 seconds. During these 72 seconds pressing of either the minimum and maximum bet function keys 135, 137 will thwart the minimum bet limit drop process, wherein without a key press intervention the drop will occur.

The closed game function key 139 is located at the bottom of the display 60″ (on the maximum bet side). This key 139 is pressed when the status of play of the game is inactive because the game is closed. Upon pressing the key 139, the game non-specific information will be displayed, along with a graphic of the casino (ie., a casino logo) where the bet minimum and maximum were located on the screen 68′. During operation of this mode, the rear screen 68R′ will display “CLOSED” to inform the casino pit personnel of the closed status of the game (and display). When in this mode, the display 60″ will display game-nonspecific information continuously at the screen 68′. In this mode, all keys except for the closed game function key 139 inactive, wherein pressing of key 139 again will cause the display to return to status of play of the game active mode, and game specific information will again be displayed.

To change game types of the display to agree with the game type being played at the game table (ie., the game type displayed on the screen 68′), the keys 133 and 139 are pressed simultaneously and released. The rear display 68R′ will then show the new game name. For example, a label “L-GAME NAME” where “L” represents “logo”, or “H-GAME NAME” where “H” represents “hotel”. Once this is displayed on the rear screen 68R′, the minimum or maximum bet function keys 135, 137 may be scrolled through. Once selected, the game choice will be implemented after 5 seconds.

Within the game types there is preferably included one or more game training titles, as for example “BJ Training”. If selected as a game type, a continuous loop game training seminar will be displayed (ie., blackjack training seminar if “BJ Training was selected) until the keys 133 and 139 are again simultaneously pressed and released to scroll to another selection (game type or other training). Before selecting a game training title, the audio functionality 141 of the display 60″ would need to be implemented.

By pressing the minimum and maximum bet function 135, 137 simultaneously and releasing, a volume indicator on the rear screen 68R′ will be displayed, whereupon the volume can be adjusted accordingly. Once adjusted, the volume indicator will disappear and revert back to the previous screen (ie., BJ Training).

Each display has a memory (as mentioned) so that when the TABLE DOWN or SHUFFLE function keys are pressed, the game minimum and maximum will remain set, as well as in the case of the display being turned off. A power cord runs through the stand and is connected to a source of power at the game table.

It is preferred that when a minimum (and/or maximum) key is pressed, it will trigger display of separate and unique game non-specific information (ie., advertisements or other messages) to that display so as to target the information to patrons frequenting that particular table game. For example, if a low minimum is displayed at Blocks 44, 51, then advertisements displayed at Blocks 46, 51 would feature inexpensive facilities of the casino, whereas if a high minimum is displayed at Blocks 44, 49, then advertisements displayed at Blocks 46, 51 would feature expensive facilities of the casino.

Turning attention now to FIGS. 8A through 9B, preferred structural implementations of the status of play of the game detectors 21a, 21b, 21c of FIG. 1, of Block 40′ of FIG. 2A, and of Block 47′ of FIG. 3A will be detailed.

Referring firstly to FIGS. 8A through 8D, a discard rack 160 is of conventional configuration for receiving cards therein, wherein one or more cards 170 conventionally locatable upon a base 162 of the discard rack. A card 170 being present in the discard rack 160 means the status of the game (as for non-limiting example, blackjack) is active. However, the absence of any card 170 in the discard rack 160 means the status of the game is inactive, wherein if the card is absent a predetermined short time, then the inactivity can be attributed the inactivity being because the game is paused (as for example during shuffling of the cards); if absent for a first predetermined longer time, then the inactivity can be attributed the inactivity being because the game is idle (as for example the game is open for play, but there are no players present); and, optionally, if absent for a second, predetermined even longer time, then the inactivity can be attributed the inactivity being because the game is closed (as for example the game is closed for play).

A card presence detector 164 is connected with the discard rack 160, wherein the card presence detector can be any sensor which automatically distinguishes card presence from absence, and provides a signal indicative of whether the card is present or absent. By way of preferred example, a conventional photocell 166 is located within the base 162, having a clear reception of light 168 above the base. Whenever a card 170 is absent (see FIG. 8D), the light falls upon the photocell 166 providing a voltage output via a wiring 172, whereby the voltage at the wiring is a signal of card absence in the discard rack 160; however, whenever a card 170 is present (see FIG. 8C), then no light will fall on the photocell 166, whereby the absence of voltage at the wiring 172 is a signal of card presence in the discard rack 160. The wiring 172 is a preferred form of a connection interface 174, as for example wires, fiber optics, wireless, etc., which connects the card presence detector 164 to the microprocessor of the display (see for example the μP 28a, 28b, 28c, respectively, of displays 10a, 10b, 10c of FIG. 1).

FIG. 9A depicts an example of a first implementation of a status of play of the game detector with respect to a blackjack game table 180. The above described discard rack 160 with card presence detector 164 is attached to the blackjack table 180, wherein a connection interface 174 connects the card presence detector 164 to the microprocessor of the display (display 60″ being shown by way of preference).

FIG. 9B depicts an example of a second implementation of a status of play of the game detector with respect to a craps table 190. A puck presence detector 192 is located in the craps table, as for example a photocell having clear light reception at a location where conventionally during play of craps the puck 194 is located prior to the first come-out roll of the dice. The presence of the puck 194 causes voltage output from the photocell to be less (than when the puck is not present) along a connection interface 174′ to the microprocessor of the display 60″″. In this regard, it is preferred to have two displays 60″′, one display at each wing, each display having a display screen 68′ (as shown at FIG. 7B (there being no rear screen)) and, additionally, the display 60″″ at the rear of the table 190 having just a rear screen 68R′ (as shown at FIG. 7A (there being no display screen 68′)), along with keys, port and internal microprocessor as mentioned regarding the display 60″. The presence of the puck is indicative the status of the game is inactive, the type of inactivity being that the game is paused.

It is to be understood from the foregoing description that the status of play of the game detector 21a, 21b, 21c may be any detector which detects the presence and/or absence of a game play article of the game with respect to the game table of the game, wherein the game play article may be for example, a card, a puck or another game play article.

Various aspects and considerations, among others, of the method according to the present invention are as follows.

Ability to display and adjust the table limits, game types and coordinating colors, independently, manually at the game or from a centralized remote station (a pit stand or a casino central location).

Ability to have the table minimum automatically reduced to another table minimum after a selected time lapse in the “TABLE DOWN” operational mode.

Ability to display interchangeable advertisements, which can be displayed at varying times and for varying duration.

Ability to target market by synchronizing advertisements in correlation with the table game limits (for example, each limit may have its own specific series of advertisements) or game types (for example, Pai Gow games may target Chinese restaurants) or game locations (for example games near a convention center may target advertisements for the convention).

Ability to manually select play of advertisement cycles at the game via the SHUFFLE and TABLE DOWN function keys.

Ability to change or program (download) new information, ie., advertisements, from a remote location.

Ability to service or maintain the system from a remote location.

Ability to carryout all of the above using wireless communication.

Ability to deliver to each display individually tailored display information and/or microprocessor programming by connecting a data storage device to the data port of the display, most preferably via a flash memory card inserted into a flash card reader port; and further to change the display information and/or the microprocessor programming simply replacing the data storage device with another having different or revised display information and/or microprocessor programming data stored therein.

Ability for pit personnel to apprehend the displayed display information, particularly game specific information, from glancing at the rear of the display.

Ability to automatically detect status of play of the game and then to automatically display game specific and/or game non-specific information responsive to the detected status.

An example of operation of Blocks 44 and 46 for a blackjack table is as follows over a 24 hour day. Block 44 operates normally. Shuffling time is estimated at 192 minutes, whereduring Block 46 is operative. Table down time is estimated at 2 hours per day, whereduring Block 46 is operative. In this example, Block 46 would be operative for about 312 minutes per day, whereduring revenues are generatable from the displayed game non-specific information (ie., advertisements).

It is to be understood that the methodology of the present invention is independent of the exact type of electronics and hardware used for its implementation. As such, in considering the method according to the present invention all electronics and hardware discussed hereinabove should be regarded merely as providing an illustration of implementation, and not a definitive and/or limiting implementation.

It is a further aspect of the present invention that the automatic detection of the status of play of the game may be combined, in any synergistic manner, with manual input (ie., casino personnel manual key press input) of status of play of the game.

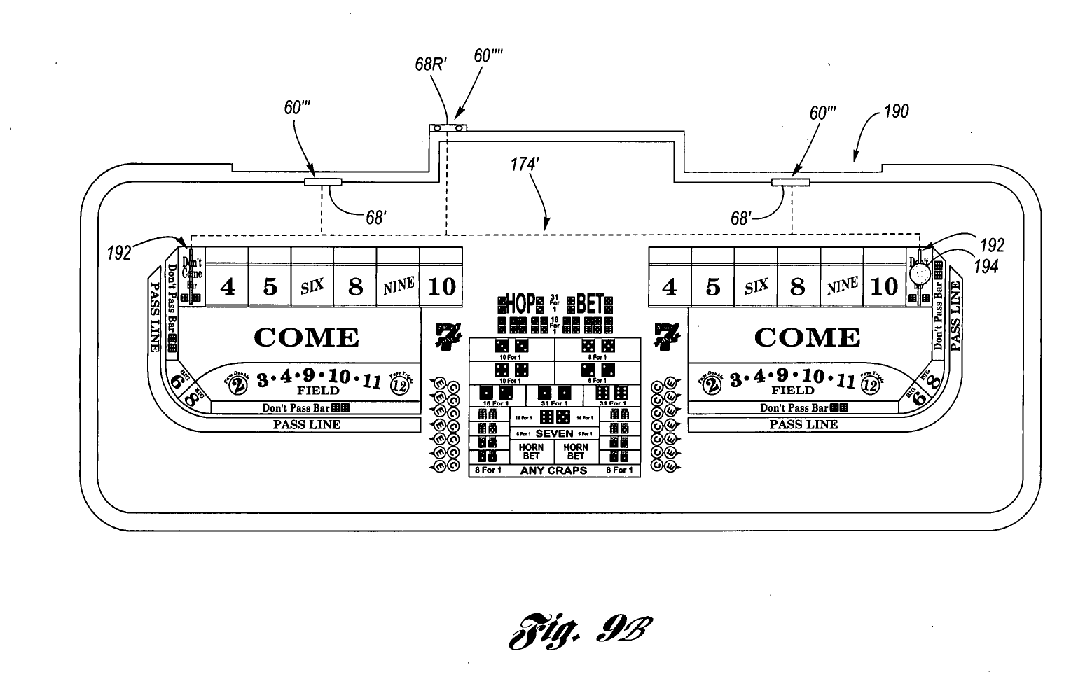

Turning attention next to FIGS. 10 through 12B, a method of implementation of the present invention will be described with respect to an exemplar flow chart 200 and exemplar display segments allocations 300, 300′, 300″ for the game non-specific information.

Referring to FIG. 10, in Block 202, a supplier obtains contracts with advertisers (as for example corporations having products or services to advertise) with respect to paid advertisements for one or more display segments (see FIGS. 11A through 11C) of the display of game non-specific information as generally described hereinabove. In Block 204, a contract is obtained by the supplier with a casino for installation of displays at table games as generally described hereinabove, wherein preferably the casino has no cost and any profit for the supplier is derived from the execution of Block 206 via the contracts obtained in Block 202, and wherein mutual agreement between Blocks 202 and 204 is present such that the casino accepts certain of the advertisers of Block 202, which may also include acceptance of the advertisements thereof, for display as display segments (see FIGS. 11A through 11C). In Block 206, the displays and associated electronics, as described hereinabove (see FIG. 1), are installed in the casino at various table games thereof, wherein the casino, as mentioned, preferably receives the installation at no cost as a result of the casino accepting the display of certain display segments of advertisers of Block 202. In Block 208, display segments of the game non-specific information are determined and allocated among the one or more of the advertisers and, preferably, also the casino, as generally based upon, and pursuant to, Blocks 202 and 204. The display segments sequentially repeat or repeat in another predetermined order, wherein the allocation in Block 208 is subject to periodic revision. The allocation in Block 208 is input, for example, at either Block 30 of FIG. 2 or Block 31 of FIG. 3, whereupon the invention as previously described is implemented (as for example via the implementations described for FIGS. 2 through 3B, above) with respect to selective display of game specific and game non-specific information.

Referring now to FIGS. 11A and 11B, an example of a display segments allocation 300 for a low betting limit (ie., a game specific information of for example “Betting Limits of $1 to $5”) and a display segments allocation 300′ for a high betting limit (ie., a game specific information of for example “Betting Limits of $25 to $500”) are shown, being rendered upon completion of either execution Block 32 or Block 33 of FIGS. 2 or 3, respectively. In this regard, by way merely of example, the game of Blackjack may have a dealer card shuffle time of 24 seconds. Accordingly, it is desirable to allocate display segments in display blocks of 8 seconds, so that during a shuffle time, whole number display segments will be displayed. Thus, in FIG. 11A there are four display blocks 302, 304, 306, 308, each 24 seconds long; and, similarly, in FIG. 11B there are four display blocks 302′, 304′, 306′, 308′, each 24 seconds long. In FIGS. 11A and 11B play time is from left to right.

With regard to FIG. 11A, by way merely of example and not limitation, the display segments are allocated and generated as programming of the game non-specific information, wherein the display segments are allocated as follows. Display block 302 is divided into three display segments, 302a, 302b, 302c, wherein: display segment 302a has a play time of 8 seconds, is allocated to a first advertiser of Block 202 and is in the form of MPEG video; display segment 302b has a play time of 8 seconds, is allocated to a second advertiser of Block 202 and is in the form of a BMP image; and display segment 302c has a play time of 8 seconds, is allocated to the casino of Block 204 and is in the form of MPEG video. Display block 304 is undivided as one display segment 304a, wherein: display segment 304a has a play time of 24 seconds, is allocated to the casino of Block 204 and is in the form of MPEG video. Display block 306 is divided into two display segments, 306a, 306b, wherein: display segment 306a has a play time of 16 seconds, is allocated to the first advertiser of Block 202 and is in the form of MPEG video; and display segment 306b has a play time of 8 seconds, is allocated to a third advertiser of Block 202 and is in the form of MPEG video. Display block 308 is divided into three time display segments, 308a, 308b, 308c, wherein: display segment 308a has a play time of 8 seconds, is allocated to a fourth advertiser of Block 202 and is in the form of a BMP image; display segment 308b has a play time of 8 seconds, is allocated to the casino of Block 204 and is in the form of a BMP image; and display segment 308c has a play time of 8 seconds, is allocated to a fifth advertiser of Block 202 and is in the form of MPEG video.

With regard to FIG. 11B, by way merely of example and not limitation, the display segments are allocated and generated as programming of the game non-specific information, wherein the display segments are allocated as follows. Display block 302′ is undivided as one display segment, 302a′, wherein: display segment 302a′ has a play time of 24 seconds, is allocated to a first advertiser of Block 202 and is in the form of MPEG video. Display block 304′ is undivided as one display segment 304a′, wherein: display segment 304a′ has a play time of 24 seconds, is allocated to the casino of Block 204 and is in the form of MPEG video. Display block 306′ is undivided as one display segment, 306a′, wherein: display segment 306a′ has a play time of 24 seconds, is allocated to a second advertiser of Block 202 and is in the form of MPEG video. Display block 308 is undivided as one display segment 308a′, wherein: display segment 308a′ has a play time of 24 seconds, is allocated to the casino of Block 204 and is in the form of MPEG video.

Turning attention now to FIG. 11C, a most preferred display segments allocation 300″ of the game non-specific information is presented. The allocation is made by determining a paused time of the game, said paused time comprising game play inactivity which is due to the game play being paused, then allocating the length of the display segments into a division of the pause time, wherein the display block composed thereof is equal to the paused time.

There are 36 display segments (each shown having its own respective number designator 1′-36′), of which thirty of the display segments are allocated for use by a casino where the displays are installed, and six of the display segments are allocated to the vendor supplying the displays. The display segments are each 8 seconds long, and can be combined, preferably providing display blocks of one display segment (8 seconds duration), display blocks of two display segments (16 seconds duration) and display blocks of three display segments (24 seconds duration). Consecutively for the entire segments allocation 300″, every three display segments constitutes a display block of 24 seconds duration, indicated by letters A through L.

By way merely of exemplification, the particular shading of each display segment is indicative of its allocation to a respective particular advertiser, wherein: display segments 1′, 2′, 18′, 19′ and 29′ are allocated to a first advertiser; display segments 3′, 4′ and 6′ are allocated to a second advertiser; display segments 5′, 7′, 8′, 11′, 14′ and 33′ are allocated to a third advertiser; display segments 9′, 10′, 12′, 13′ and 28′ are allocated to a fourth advertiser; display segments 15′, 16′ and 17′ are allocated to a fifth advertiser; display segments 20′, 21′ and 22′ are allocated to a sixth advertiser; display segments 23′, 24′, 25′, 30′, 31′ and 32′ are allocated to a seventh advertiser; display segments 26′ and 27′ are allocated to an eighth advertiser; and, finally, display segments 34′, 35′ and 36′ are allocated to a ninth advertiser. By further exemplification, the display segments of FIG. 11C have been sold to advertisers in which display segments number 3′, 4′, 6′, 34′, 35′ and 36′ are allocated to the vendor, and the remaining display segments are allocated to the casino.

By way merely of example, the displaying of the display segments in FIGS. 11A through 11C may sequentially repeat, or go on to other pre-programmed display blocks, until modified per FIG. 10.

Referring back to the implementation algorithms of FIGS. 2 through 3B as they pertain to the preferred display segments allocation 300″ of FIG. 11C, FIG. 12A exemplifies the execution of Block 56 of FIG. 2A and the execution of Block 64 of FIG. 3A, wherein when display of game non-specific information is to end, play P₁ is less than 50% into display block F at about the end of display segment 16, so the next play P₂ will be restarted at the beginning of display block F (corresponding to the beginning of display segment 16); whereas FIG. 12B exemplifies the execution of Block 55 of FIG. 2A and the execution of Block 63 of FIG. 3A, wherein when display of game non-specific information is to end, play P′₁ is more than 50% into display block F, so play continues through the end of the display block (corresponding to the end of display segment 19), then the next play P′₂ will be started at the beginning of the next display block G (corresponding to the beginning of display segment 19).

To those skilled in the art to which this invention appertains, the above described preferred embodiment may be subject to change or modification. Such change or modification can be carried out without departing from the scope of the invention, which is intended to be limited only by the scope of the appended claims.

1. A method for providing dynamic casino game signage with selectable messaging timed to play of a table game, comprising the steps of:
obtaining one or more contracts with one or more advertisers for advertising at one or more predetermined display segments of game non-specific information of a predetermined game;
obtaining a contract with a casino to provide a respective display at one or more game tables of the predetermined game;
providing an electronic display, respectively, at the one or more game tables;
allocating the display segments of the game non-specific information into display blocks among the one or more advertisers;
providing display information comprising game specific information which is related to the game and the game non-specific information which is unrelated to the game;
automatically detecting status of play of the game; and
selectively displaying at the display the game specific information and selectively displaying at the display the game non-specific information, wherein the selections are at least in part responsive to the automatically detected status of play of the game.

2. The method of claim 1, wherein said step of automatically detecting comprises automatic detection of at least one of presence and absence of a game play article of the game with respect to at least one predetermined location associated with the one or more game tables.

3. The method of claim 1, wherein the selections are entirely responsive to the automatically detected status of play of the game.

4. The method of claim 1, wherein said step of automatically detecting comprises automatic detection of presence and absence of a card at a predetermined location associated with a game table of the one or more game tables;
wherein detected presence of a card indicates the status of play of the game at the table is active; and
wherein detected absence of a card indicates the status of play of the game at the table is inactive.

5. The method of claim 4, wherein the automatic detection comprises a sensor sensing the presence and absence of a card with respect to a discard rack.

6. The method of claim 2, wherein said step of selectively displaying comprises:
selectively displaying at the display the game non-specific information if said step of detecting determines the status of play of the game is inactive; and
selectively displaying at the display the game specific information if said step of detecting determines the status of play of the game is active.

7. The method of claim 6, wherein said step of selectively displaying further comprises:
selectively displaying the game specific information and the game non-specific information if said step of detecting determines the status of play of the game is inactive because of the play being at least one of idle and paused;
selectively displaying only the game non-specific information if said step of detecting determines the status of play of the game is inactive because of the play being closed; and
selectively displaying only the game specific information if said step of detecting determines the status of play of the game is active.

8. The method of claim 7, wherein when the displaying of a currently playing display block of the game non-specific information is terminated responsive to said step of detecting, said termination comprises:
determining a percent of play of the currently playing display block;
completing play of the display block if the percent is more than a predetermined percentage;
immediately stopping play of the display block and resetting to the beginning of the display block if the percentage is less than the predetermined percentage; and
executing the termination.

9. The method of claim 8, wherein said step of selectively displaying further comprises:
changing the displayed game specific information if said step of detecting determines the status of play of the game has been idle a predetermined length of time, wherein the change encourages play of the game by adjusting betting limits of the game.

10. The method of claim 9, wherein said step of selectively displaying further comprises:
selectively displaying the game non-specific information according to predetermined selection criteria, said selection criteria comprising a predetermined relationship to at least one of: the game, the game table, the game table location, and the game specific information.

11. The method of claim 10, wherein said step of providing information further comprises:
wirelessly transmitting at least one of the game specific and game non-specific information to the display.

12. The method of claim 10, wherein said step of providing information further comprises:
physically delivering at least one of the game specific and game non-specific information to the display.

13. The method of claim 1, wherein said step of allocating comprises:
determining a paused time of the game, said paused time comprising game play inactivity which is due to the game play being paused;
allocating the length of the display segments into a division of the pause time, wherein the display block composed thereof is equal to the paused time.

14. The method of claim 13, wherein said step of automatically detecting comprises automatic detection of at least one of presence and absence of a game play article of the game with respect to at least one predetermined location associated with the one or more game tables.

15. A method for providing dynamic casino game signage with selectable messaging timed to play of a table game, comprising the steps of:
providing display information comprising game specific information which is related to the game and game non-specific information which is unrelated to the game;
providing an electronic display at a respective game table;
automatically detecting status of play of the game; and
selectively displaying at the display the game specific information and selectively displaying at the display the game non-specific information, wherein the selections are at least in part responsive to the automatically detected status of play of the game.

16. The method of claim 15, wherein said step of automatically detecting comprises automatic detection of at least one of presence and absence of a game play article of the game with respect to at least one predetermined location associated with the one or more game tables.

17. The method of claim 15, wherein the selections are entirely responsive to the automatically detected status of play of the game.

18. The method of claim 15, wherein said step of automatically detecting comprises automatic detection of presence and absence of a card at a predetermined location associated with a game table of the one or more game tables;
wherein detected presence of a card indicates the status of play of the game at the table is active; and
wherein detected absence of a card indicates the status of play of the game at the table is inactive.

19. The method of claim 18, wherein the automatic detection comprises a sensor sensing the presence and absence of a card with respect to a discard rack.

20. The method of claim 16, wherein said step of selectively displaying comprises:
selectively displaying at the display the game non-specific information if said step of detecting determines the status of play of the game is inactive; and
selectively displaying at the display the game specific information if said step of detecting determines the status of play of the game is active.

21. The method of claim 20, wherein said step of selectively displaying further comprises:
selectively displaying the game specific information and the game non-specific information if said step of detecting determines the status of play of the game is inactive because of the play being at least one of idle and paused;
selectively displaying only the game non-specific information if said step of detecting determines the status of play of the game is inactive because of the play being closed; and
selectively displaying only the game specific information if said step of detecting determines the status of play of the game is active.

22. The method of claim 21, further comprising the steps of:
providing a plurality of display segments comprising the game non-specific information;
allocating the display segments of the game non-specific information into display blocks;
wherein when the displaying of a currently playing display block of the game non-specific information is terminated responsive to said step of detecting, said termination comprises:
determining a percent of play of the currently playing display block;
completing play of the display block if the percent is more than a predetermined percentage;
immediately stopping play of the display block and resetting to the beginning of the display block if the percentage is less than the predetermined percentage; and
executing the termination.

23. The method of claim 22, wherein said step of selectively displaying further comprises:
changing the displayed game specific information if said step of detecting determines the status of play of the game has been idle a predetermined length of time, wherein the change encourages play of the game by adjusting betting limits of the game.

24. The method of claim 23, wherein said step of selectively displaying further comprises:
selectively displaying the game non-specific information according to predetermined selection criteria, said selection criteria comprising a predetermined relationship to at least one of: the game, the game table, the game table location, and the game specific information.

25. The method of claim 24, wherein said step of providing information further comprises:
wirelessly transmitting at least one of the game specific and game non-specific information to the display.

26. The method of claim 24, wherein said step of providing information further comprises:
physically delivering at least one of the game specific and game non-specific information to the display.

27. The method of claim 22, wherein said step of allocating comprises:
determining a paused time of the game, said paused time comprising game play inactivity which is due to the game play being paused;
allocating the length of the display segments into a division of the pause time, wherein the display block composed thereof is equal to the paused time.

28. A system for providing dynamic casino game signage with selectable messaging timed to play of a table game, comprising:
an electronic display located at a respective game table of a game;
means for providing said display with display information comprising game specific information which is related to the game and game non-specific information which is unrelated to the game;
means for automatically detecting status of play of the game; and
means for selectively displaying at said display the game specific information and selectively displaying at said display the game non-specific information, wherein the selections are at least in part responsive to the detected status of play of the game.

29. The system of claim 28, wherein the selections are entirely responsive to the automatically detected status of play of the game.

30. The system of claim 28, wherein said means for automatically detecting comprises a sensor connected with said means for selectively displaying, said sensor detecting at least one of presence and absence of a game play article at a predetermined location with respect to the game table.

31. The system of claim 30, further comprising means for wirelessly delivering the display information to said display.

32. The system of claim 30, further comprising means for physically delivering the display information to said display.

33. The system of claim 30, further comprising a plurality of said displays for at least one game played at a plurality of the game tables, one display, respectively, for each game table, wherein at each game table is played a respective game of the at least one game.

34. The system of claim 28, wherein said means for automatically detecting comprises:
a discard rack;
a sensor located with respect to said discard rack, wherein said sensor senses presence and absence of a card placed in said discard rack; and
an interconnection between said sensor and said means for selectively displaying.

35. The system of claim 34, wherein said sensor comprises a photocell located at a base of said discard rack.

36. The system of claim 34, further comprising means for wirelessly delivering the display information to said display.

37. The system of claim 36, wherein said sensor comprises a photocell located at a base of said discard rack.

38. The system of claim 34, further comprising means for physically delivering the display information to said display.

39. The system of claim 38, wherein said sensor comprises a photocell located at a base of said discard rack.

40. The system of claim 34, further comprising a plurality of said displays for at least one game played at a plurality of the game tables, one display, respectively, for each game table, wherein at each game table is played a respective game of the at least one game.

41. The system of claim 40, wherein said sensor comprises a photocell located at a base of said discard rack.

42. A status of play of a table game detector, comprising:
a discard rack;
a sensor located with respect to said discard rack, wherein said sensor senses presence and absence of a card placed in said discard rack;
wherein said sensor provides an output indicative of the detected presence.

43. The detector of claim 42, wherein said sensor comprises a photocell located at a base of said discard rack.
